(19) United States
(12) Patent Application Publication
(10) Pub. No.: US 2004/0133445 A1
(43) Pub. Date: Jul. 8, 2004

(54) Generic framework for applying object-oriented models to multi-tiered enterprise applications

(75) Inventors: Surya Rajan, Houston, TX (US); Britt Samuel Poulsen, Missouri City, TX (US); Carl Patrick Seaton, Sugar Land, TX (US); Kim Liew, Houston, TX (US); Louis Alberto Castaneda, Redmond, WA (US); Suneet V. Bhatte, Houston, TX (US); Sankar Subbiah, Houston, TX (US)

Correspondence Address: BAKER BOTTS, LLP, 910 LOUISIANA, HOUSTON, TX, 77002-4995, US

(73) Assignee: Marathon Ashland Petroleum L.L.C.

(21) Appl. No.: 10/695,622

(22) Filed: Oct. 28, 2003

Related U.S. Application Data
(60) Provisional application No. 60/421,971, filed on Oct. 29, 2002.

(51) Int. Cl. G06F 17/60

(52) U.S. Cl. 705/1

(57) ABSTRACT

A system and method are provided for the structured, rapid development and deployment of software components that together, would constitute a robust multi-tiered enterprise software application. Four sub-components are provided for handling various aspects of the business objects. A client framework is used to interact with client users and client software processes. A database framework is used to handle data retention and search functions. An external framework is used to interact with software processes that are outside the gambit of the present system. Finally, a business framework is used to operate the business objects themselves. The business framework can be configured under the services of a transaction server.

### CROSS-REFERENCE TO RELATED APPLICATIONS

This application is a conversion of, and claims priority to, Provisional U.S. patent application serial No. 60/421,971, filed Oct. 29, 2002, entitled, “GENERIC FRAMEWORK FOR APPLYING OBJECT-ORIENTED MODELS TO MULTI-TIERED ENTERPRISE APPLICATIONS,” by Rajan, et al; this application is also related to U.S. patent application Ser. No. 10/190,443, filed Jul. 8, 2002, entitled, “OBJECT ORIENTED SYSTEM AND METHOD FOR PLANNING AND IMPLEMENTING SUPPLY-CHAINS,” by Magers, et al., both applications being incorporated herein by reference, in their entirety, for all purposes.

### BACKGROUND OF THE INVENTION TECHNOLOGY

1. Field of the Invention

The present invention is related to multi-tiered enterprise applications. More specifically, the present invention is related to a framework for creating multi-tiered software implementations of models that simulate enterprise operations, such that the process of creation, management, and maintenance of such multi-tiered enterprise software applications is best optimized.

2. Description of the Related Art

Current multi-tiered enterprise application management tools typically model one of the elements of a multi-tiered enterprise application, such as a supply chain, or other business endeavor. For example, some supply chain systems focus on the transport of the commodity. Other modeling systems focus on the contract formation, still others on collaboration or messaging, yet still others concentrate on the scheduling. Other types of multi-tiered enterprise applications include banking applications (linking banks to customers), a personnel systems (linking employees to companies), or any other system that links one or more elements of one business enterprise to another enterprise, or to another element within the same enterprise. Such enterprise applications allow companies to streamline their internal processes, link with their supply chains, link with their customers; and/or create new products quickly that are mass-customized.

To facilitate enterprise software development, ENTERPRISE JAVA BEANS® (“EJB”), produced by Sun Microsystems of Mountain View, Calif., was developed to provide a server-side component architecture. Third-party companies build transaction servers that conform to the EJB architecture. In addition, the common object model (“COM+”) was made available by the Microsoft Corporation of Redmond, Wash. However, COM+ is not an architecture like EJB. Rather, COM+ is a transaction server and an enterprise software application that is written for COM+ and can avail itself of COM+ services. Yet another standard is the common object request broker architecture (“CORBA”), which is available from the Object Management Group of Needham, Mass.

When building a new enterprise system, the choice between CORBA, EJB and COM+ is difficult. EJB provides a server-side architecture that specifies how business objects are organized and how a business object can access transaction server services. COM+, on the other hand, is a more low-level methodology that simply provides services. Under the COM+ regime, how business objects are organized is left to the enterprise architecture team. However, what COM+ does offer is integration with other Microsoft software, such as MICROSOFT OFFICE® and INTERNET EXPLORER®, which are both manufactured by the Microsoft Corporation of Redmond, Wash. Due to its prevalence on the desktop (client) devices, integration with Microsoft software is a compelling reason to use COM+. Therefore, a need has developed in the industry for an enterprise architecture that facilitates integration with COM+, EJB, CORBA or other industry standards, yet is not simply a server-side architecture or object broker. Moreover, there is a need for an architecture that encompasses all tiers of an enterprise system including client-side, server-side, database, and external (such as two-way access to external applications and external data).

The desired architecture would comprise an end-to-end solution for enterprise system development. The need exists for a solution that allows the enterprise system to keep up with the changes in business models and communication capabilities. The desired solution would also perform well, be scalable, preferably clustered, and contain other features that are characteristic of a robust enterprise system.

Tools for generating multi-tiered enterprise applications are also lacking. As the greatest value that can be added is the application of tailored multi-tiered enterprise application models to current conditions, a premium is placed on the ability to generate models for potential changes to enterprises and their business models. Recent advances in rapid application development (“RAD”) software enable the modeling of objects, such as EJB, quickly. While one can build client forms that work with EJB, EJB does not provide a mechanism for mass-producing client forms. Further, EJB does not provide RAD integration of the middle and data tiers. The middle and data tiers in enterprise software applications are tightly coupled. However, previously, there had been no RAD mechanism for coupling the two such that there is compile-time checking between them, they are of high performance, or that they have consistent naming conventions, etc. Moreover, EJB does not provide heterogeneous application integration. EJB does not provide a way for the middle tier to talk to heterogeneous applications such that: there is compile-time checking between them; they employ consistent naming conventions, etc. EJB also fails to provide advanced business object features such as: inheritance among business objects; business objects capable of converting automatically into other business objects; and advanced error support. In addition, while EJB vendors can capture operating system exceptions, they do not display the entire call stack, including line numbers, when errors are found. Finally, EJB does not provide transaction server independence. One can only debug or test an EJB application from inside EJB. That means one must deploy the business components into the EJB container. Deploying the EJB within the EJB container is a time-intensive activity. It is desirable for the enterprise application to run the same (transactionally) whether inside a transaction server or not.

Consequently, because of the shortcomings of the various enterprise software tools, the industry has needed a way to have an overall synergistic framework, where all of the constituent parts act as one. This synergistic framework would have RAD through all tiers and high performance throughout. A desirable RAD system would also have a consistent naming convention for the constituent parts and an enforcement mechanism for ensuring adherence to the various conventions. In addition, a desirable RAD system would facilitate code reuse and provide an end-to-end solution that correctly models current multi-tiered enterprise applications, such as supply chains and potential supply chains that have disparate business models. There is also a need in the art for a system and method for generating multi-tiered enterprise models that can be used to manage existing multi-tiered enterprise applications, e.g., supply chains, or to develop new models that are optimized to the problem or market at hand.

### SUMMARY OF THE INVENTION

The present invention comprises a method and system for developing an enterprise system having one or more tiers. Moreover, the present invention is a method for organizing components within each tier of the enterprise system, such that synergies are formed within and between the tiers. The present invention, therefore, is comprised of the method and system that describes the framework components and the method that describes the organization of the tier components. The purpose of the invention is to maximize any synergy within a tier and among different tiers of the enterprise application.

The invention comprises a client tier (also called the presentation tier), a business tier (also called the middle tier), a database tier, and an external tier (which allows for integration with external software and/or external data). Each tier of the enterprise system may contain one or more framework components (that provide services for tier components), tier components (that are components that implement an enterprise's business logic), or both, as well as other components.

The present invention can be used by any enterprise. Therefore, the present invention does not purport to describe a particular enterprise's business processes. Rather, the present invention describes the composition of framework components used for each tier. The present invention also describes the organization of tier components, but only insofar as the ways in which tier components interact with the framework components.

The invention creates synergy among tiers of the enterprise system. This synergy results in rapid development of each tier, high performance, and heterogeneous application integration. Development of each tier is rapid because the present invention includes rapid development of tier components and their business process, as well as rapid development of framework components of the tier. The present invention also provides high performance both between two or more tiers, and within a single tier. The present invention thoroughly utilizes high performance tactics and development techniques. Finally, the present invention allows different applications, and different data, to be used by the enterprise system and vice-versa, thereby facilitating a heterogeneous operating environment.

The present invention provides a system, such as a computer system, having a processor, memory operative with the processor, and storage media that is operative with the processor. The present invention uses the system to implement a business framework, a database framework that is operative with the business framework, a client framework that is operative with the business framework, and an external framework that is operative with the business framework. The business framework, the database framework, the client framework and the external framework can be combined into an enterprise system framework. Moreover, the various frameworks can work together in distinct combinations of one or more frameworks for specific applications.

The enterprise system framework of the present invention can provide many services. For example, one embodiment of the invention has the enterprise system framework including rapid development services, such as developer services that allow developers to execute the enterprise system framework from a local computer system without configuring the enterprise system framework. Moreover, the developer services allow developers to execute the enterprise system framework with or without security and to debug stored procedures.

The business framework provides rapid development services to develop the enterprise applications. The rapid development services generate a new business framework that is an abstraction of the business framework itself. The business framework abstraction allows the business framework to modify the new business framework services that the new business framework will provide to the business objects. The business framework abstraction also allows the business framework to modify a business framework methodology. The business objects of the present invention can be distributed on one or more servers or other devices.

The present invention can include a set of central services on business objects, such as administrative services. The administrative services allows the business framework to track system usage, to track one or more users on the system, and/or to garner performance metrics.

The business framework can provide the set of central services for one or more business objects. For example, the set of central services provided by the business framework includes transaction services that are provided by, for example, a COM+ transaction server or by the business framework itself. The set of central services may also include security services to control the access to one or more users to the business objects.

The set of central services may also include security services to control the access of one or more users to the business objects. The security services can utilize pre-defined and/or dynamic protocols, rules, and conventions. Alternatively, the security services can utilize a security schema that is provided by an external service provider. Typically, the security services are abstracted from an external service provider's implementation and can include the automatic generation of special components that form walls around the business objects in order to control access to the business objects.

The set of central services may also include organizational services. The organizational services include a mechanism that requires business objects to belong to one or more groups, such as a business group. Another organizational service is to identify the business objects that belong to the client framework. Yet another organizational service is the compulsory naming conventions for the various business objects, which aid greatly in the generation, debugging, and maintenance of business objects.

The set of central services may also include protocol services. The protocol services enable a protocol to be abstracted from communications between business objects, various frameworks, external services or external customers. The protocol services also enable different business objects to use different protocols, including a protocol based on a special group to which the business object belongs.

Another of the central services includes adapter services. Adapter services allow the business objects to invoke other computer systems, such as those implementing the database framework. The adapter communicating with the database framework allows the business objects to be fetched from a database and placed into one of the other business objects in a single operation. The adapter services also allow business objects to be abstracted from an adapter that is used by the business object. The particular adapter that is used by the business object is determined by the special group to which a business object belongs. The adapter services allow adapters to communicate with computer systems in the protocol or data access technology that the computer system supports. The computer systems of the present invention include computer systems that implement the external framework and other frameworks and services.

The set of central services on business objects further includes error-handling services. The error-handling services support the capturing of operating system exceptions or communication applications (e.g., COM/COM+) errors. The error-handling services can also provide the logging of errors in an event viewer when errors are captured. The error-handling services further include the generation of call stacks that may include line numbers when errors are captured and/or detected.

The set of central services on business objects may also include layering services. The layering services include a client framework layer, an external framework layer, and a reporting system layer. The named client framework layer enables the client framework and the business framework to interact with a minimum of roundtrips and in an abstracted fashion. The named external framework layer also enables the external framework and the business framework to interact with a minimum of round- trips and in an abstracted fashion. The named reporting system layer enables the reporting system and the business framework to operate in an abstracted fashion.

The set of central services on business objects further includes life-cycle services. The life-cycle services include notifying business objects after the business objects have been created, and before and after they are updated, deleted, and/or fetched.

The set of central services on business objects further includes rapid development services. The rapid development services allow business objects that are not tied to the database to be generated automatically. The business objects typically consist of a layer of non-generated code and a layer of generated-if-not-existing code. The rapid development services also allow business objects that are tied to a database table or a database view to be generated automatically. In some instances, however, the business objects consist of a layer of non-generated code, a layer of generated code, and a layer of generated-if-not-existing code. The layer of non-generated code provides generic services for the business objects. The rapid development services allow business objects to make copies of themselves automatically. Moreover, the layer of non-generated code guarantees that the layer of generated code implements certain services, for example, to assist the layer of generated code. The layer of generated code and the layer of generated-if-not-existing code can be created with (by) a third-party tool. While the layer of generated code can be overwritten, in some cases, the layer of generated code is overwritten constantly. The overwriting of the layer of generated code can be accomplished by a developer, and in doing so, allows the developer to extend the behavior of the business object or to modify the default behavior of the business object.

The business objects can include state objects, collections of state objects and stateless business objects. The state objects can encapsulate one or more rows of the database table or the database view such that the encapsulation is done within the layer of generated code for the state object. The layer of generated code can automatically contain, for example, get and put member functions which retrieve and store data, respectively, where the data match the database schema. If the layer of generated code contains the get and put member functions, then there exists compile-time checking between the business object and database schema. The layer of generated code can automatically contain member variables (data parameters) that match the database schema. In yet another feature of the present invention, the member variables of the business objects can be objects rather than, for example, raw C++ types, where the corresponding database type is a calendar, a unit, a primary key, or a binary file.

The layer of generated code can contain status flags. The status flag indicates whether the state object is a new state object, a state object that has changed, or a state object that is to be deleted. The state objects also keep status flags on each member variable. This status flag indicates whether the member variable has changed or not. Status flags are automatically updated by the business framework.

The state collection objects encapsulate zero or more state objects. The state collection object is compile-time bound to its corresponding state object. This prevents state objects from one business object being mistakenly passed to another state collection object. The state collection object is implemented using a container algorithm such as linked-list and/or a hash-table. In the preferred embodiment, the container algorithm is abstracted into a separate object. This enables each state collection object to be light-weight and enables state collection objects to support new container algorithms easily.

The stateless business object, in their layer of generated code, can include methods for communicating with stored procedures associated with the database table or view that the business object is associated with. If the stored procedures for the database table or view are added, removed, or changed, the stateless business object will be recast or recompiled with different methods that reflect the modification to the stored procedure or other entry point. In addition, if other business objects use these methods, then there is compile-time checking between stored procedures and business objects. The stateless business objects are compile-time bound to their corresponding state objects and state collection objects. This prevents state objects or state collection objects from one business object to be mistakenly passed to another business object.

The rapid development services of the present invention allow run-time binding of business objects with extensible markup language (“XML”) schema definition (“XSD”) schema. If the XSD schema changes, the validation of the business object will likely fail. Employment of the above-described services allows business objects to inherit from each other. However, this type of inheritance is not the traditional programming kind of inheritance. Instead, in this type of inheritance, one business object is attached to another business object such that when the user tries to derive a new business object from one of the (attached) parent objects, then both (attached) parent objects are fetched, derived, and attached as the result. Thus, when the derived object is changed, both (attached) objects are changed. When one of the derived business objects is deleted, the attached object is deleted as well.

The rapid development services allow business objects to convert automatically from one business object to another. A developer can override this feature, if desired, to change the default behavior.

The rapid development services also enable automatic replay of deadlock database errors when detected and enable business objects to keep copies, optionally and automatically, of their old state. This allows a business object to know how it has changed. The business framework automatically updates the old state after a business object is inserted or has been updated in the database.

The set of central services on business objects includes messaging services. The messaging services allow business objects to send electronic mail (“email”) or messages to other users or computer systems. The messaging services include message queue services that enable asynchronous method invocation between business objects, and enable business objects to be invoked immediately or at a specific date and time. The message queue services also enable business objects to be invoked, even in case of some mechanical failure or other failure of, for example, the system that supports a part of the service. Finally, the message queue services are available even when the application is not configured in a transaction server.

The set of central services on business objects further includes asynchronous services. The asynchronous services include the ability for business objects to invoke each other in an asynchronous manner. Fortunately, the asynchronous services do not preclude the ability for business objects to invoke each other in a synchronous manner. As with the messaging services, the asynchronous services are available even when the application is not configured in a transaction server. The asynchronous services are optimized for high-performance communication.

The set of central services on business objects further includes scheduling services. The scheduling services allow business objects to be invoked once at a given date and time, or periodically at specified intervals.

The set of central services on business objects further includes reporting services. The reporting services allow integration with, for example, CRYSTAL REPORTS® which is produced by Crystal Decisions, Inc. of Palo Alto, Calif. The reporting services provide rapid development for reports and may include the addition of CRYSTAL REPORTS® binding functions in state objects.

The database framework consists of stored procedures, user-defined data types, and tables. The database framework may also include views in, for example, a relational database such as MS SQL SERVER 2000® database that is produced by the Microsoft Corporation. Preferably, there is a single point of entry to the database framework, such as through one or more stored procedures. However, use of other entry points besides (or in addition to) stored procedures is possible. The stored procedures, user-defined types, tables, and views all follow naming conventions to ease development and aid in debugging and/or maintenance. Moreover, the naming conventions allow a third-party tool to identify all of the insert, update, delete, and query stored procedures that correspond to each table and view. That identification allows a third-party tool to generate automatically all of the insert, update, and delete stored procedures that correspond to all tables and views in the database. That generation capability allows stored procedures to support simultaneous access by multiple users easily, to support keeping history automatically, and to support more services rapidly. Finally, the user-defined types enable database columns to identify themselves as components within a unit system.

The client framework provides rapid development services for the client framework. The rapid development services enable the client framework to change central services for client forms and client dialogs en masse. The client framework provides a set of central services for certain items, such as client forms, client dialogs, and HTML pages. The central services include services to abstract client forms and dialogs from the web browser that hosts them.

The central services of the client framework include life-cycle services. The life-cycle services include notifying client forms and client dialogs to initialize themselves and to notify the client forms and client dialogs when either the get, save, refresh, and/or delete buttons have been pressed. The life-cycle services allow client forms and client dialogs to override default behavior by not passing life-cycle messages to the client framework.

The central services of the client framework include performance services. The performance services include caching services, such as routing all outbound calls through a cache so that the outbound call need not be made if the results are already in the cache. The caching services may be implemented in C++ for high-performance, but may also be implemented in other programming languages as well.

The performance services of the client framework may include asynchronous services. The asynchronous services typically provide services that enable client objects to invoke server objects in an asynchronous manner. Such services include asynchronous downloading services that enable the downloading of client forms and objects in the background (e.g., as a background process or thread). The performance services can make client forms, client dialogs and the client framework itself lightweight. The performance services use business objects natively. Controls, forms, and dialogs within the client framework use business objects as their data model.

The central services of the client framework include persistence services. The persistence services allow HTML page-state to be preserved. When leaving a form, the form's state is preserved. When returning to the form, the form will re-load from the saved state.

The central services of the client framework include rapid development services. The rapid development services include automatic updating of the status flags of business objects. The rapid development services may also include property services. The property services enable controls on, for example, HTML pages, to exhibit behavior based on properties defined on the control. The exhibited behavior allows forms and dialogs to invoke business objects without coding. The exhibited behavior includes loading controls from specific business object data, taking action on control selection, taking action when the use invokes commands such as get, save, delete, refresh, and/or request history of one or more objects. The commands can be invoked through a graphical user interface (“GUI”) widget (such as a button), or through a command line interface, or through other types of input mechanisms.

The rapid development services can use programming languages such as VISUAL BASIC®, available from the Microsoft Corporation, as the language for client forms and client dialogs, although other languages and/or GUI widgets can be used. The rapid development services further include integration with a deployment apparatus. The integration allows a deployment apparatus to discover all binaries needing to be installed on a client machine.

The external framework operates within, for example, the WEBMETHODS® application enterprise software, available from WebMethods, Inc. of Fairfax, Va. The external framework provides a set of central services. One of those central services is a protocol service. The protocol services include a protocol framework such that new protocols can be “plugged in” to the present invention. The central services may also include communication services. The communication services include synchronous invocation services that allow synchronous method invocation between objects within the external framework and external clients. The communication services further include publish/subscribe invocation services. The publish/subscribe services allow external framework objects to publish events asynchronously. Clients within the external framework and/or clients outside the external framework can subscribe to these events. All of the information within the external framework is preferably in an open or agreed-upon format to facilitate easy and accurate communications between objects, processes, and applications.

The central services further include abstraction services. The abstraction services allow external clients, such as external software applications that interact with the system, to be abstracted from the external framework. The abstraction services also allow the business framework to be abstracted from the external framework.

The central services of the external framework include rapid development services. The rapid development services of the external framework include the ability to conduct run-time validation automatically between external clients and the external framework. The rapid development services further include the ability to conduct run-time validation automatically between the external framework and the business framework.

The developer services of the present invention allow developers to debug the enterprise system framework with security. The developer service also allows a developer to debug the enterprise system framework from his/her local computer system without having to configure the enterprise system framework in, for example, COM+, a web server, or any other third-party server software. The developer service further allows a developer to debug the enterprise system framework without security (if desired). Generally, the rapid development services generate a business framework abstraction of the business framework from one or more business objects. The rapid development services also generate a business framework abstraction of the business framework from one or more business objects through a layer of generated code. The business framework abstraction allows the business framework to modify a business framework methodology without affecting one or more business objects.

The administrative services allows the business framework to track one or more users of the system to garner performance metrics. The business object groups of the present invention include one or more special groups. The special groups include groups identifying business objects as belonging to the external framework and groups identifying business objects as belonging to a reporting system. Finally, the business objects can be distributed on more than one server, with performance being optimized for such distribution.

A method is provided for implementing the framework of the present invention. The method of the present invention addresses the implementation of code for various aspects of the present invention, namely, user interfaces (client framework), database integration (database framework) and business logic (business framework). In one aspect of the method of the present invention, data structures are provided to the database framework. User interface information is provided to the client framework, code instructions are provided to the business framework, and business requirements are translated into technical specifications used to generate the business objects of the business framework. The general method can be extended to generating code for the data structures defined above. In another example, the user interface information can be used to generate user interface code. In yet another example, the generated code can be used to provide software business services.

In order for the method of the present invention to model or implement an enterprise business, it must be able to accommodate business-related logic into the model. The present invention has the capability to allow business analysts to provide business-logic and to combine that business-logic with technical requirements, as defined by a developer. The developer's technical requirements are combined with the business-logic (business requirements) from the business analyst and are translated into technical specifications that are used to generate code and logic for one or more frameworks of the present invention. This translation process can utilize (or require) several sub-aspects for the frameworks. For example, the developer may be able to identify user interface requirements, and use the present invention to generate user interface code for incorporation into the client framework. The developer can also use the present invention to generate business objects that process data that have various methods and functions. At each step, or at intermediate times throughout the method, the code that is generated by the present invention can be built and/or compiled to ensure that the generated code is functional and also correctly implements the desired features and functionality. While the present invention generates code, opportunities are provided to the developer to insert custom business-logic within the generated code to modify the functionality of the generated code. As before, the code that was modified with the custom features can be compiled to test the integrity of the modified code. Additional testing can be performed to test the integration of the user interface to the business-logic to determine if the user interface is able to communicate with the business layers.

Additional steps of the method of the present invention are used to define the required data structure, to connect to the database and to implement the required data structures in the database to form an implemented data structure. As before, the data structure in the database (generated as a result of the framework of the present invention) can be verified as equivalent to said required data structure. Data access components can be generated with the implemented data structure.

Data access tests can be performed with the business components and the client components to determine whether the data access components integrate correctly with the user interface layer and/or the business layer. The method of the present invention can be extended to include: the preparation of an external data interface; the identification of data structures associated the external data interface; and the generation of external access components. As with other aspects of the present invention, once a code generation step has been completed, the intermediate (or final) versions of the code can be compiled to ensure their validity. In the case of the external access component, they can be defined, preferably, in an XML schema or other mechanism that enables structured data exchange. Once all of the required code has been generated, it can be executed. It is preferable, however, to verify the code that was generated with the framework of the present invention. In the cases where the framework-generated code is modified for specific business logic, then that modified code can also be executed. It is preferable, however, to verify the code at intermediate steps along the method of the present invention to simplify debugging should errors be encountered.

### BRIEF DESCRIPTION OF THE DRAWINGS

A more complete understanding of the present disclosure and advantages thereof may be acquired by referring to the following description taken in conjunction with the accompanying drawings, wherein:

FIG. 1 is a block diagram illustrating the four sub-frameworks according to the teachings of the present invention.

FIG. 2 is a block diagram illustrating the business framework according to the teachings of the present invention.

FIG. 3 is a block diagram illustrating the client framework according to the teachings of the present invention.

FIG. 4 is a block diagram illustrating the database framework according to the teachings of the present invention.

FIG. 5 is a block diagram illustrating the external framework according to the teachings of the present invention.

FIG. 6 is a block diagram illustrating the relationship UsControls and the UsControlBase according to the teachings of the present invention.

FIG. 7 is a block diagram illustrating the relationship between the system packages and other packages within the external framework according to the teachings of the present invention.

FIG. 8 is a flowchart illustrating the overall method of the present invention.

FIG. 9 is a flowchart illustrating the method for generating database technical specifications according to the teachings of the present invention.

FIG. 10 is a flowchart illustrating the method for generating business technical specifications according to the teachings of the present invention.

FIG. 11 is a flowchart illustrating the method for generating client technical specifications according to the teachings of the present invention.

FIG. 12 is a flowchart illustrating the method for generating external technical specifications according to the teachings of the present invention.

FIG. 13 s a block diagram illustrating several elements of the business framework according to the teachings of the present invention.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives and equivalents falling within the spirit and scope of the invention, as defined by the appended claims, are to be covered.

### DETAILED DESCRIPTION OF SPECIFIC EMBODIMENTS

Overview

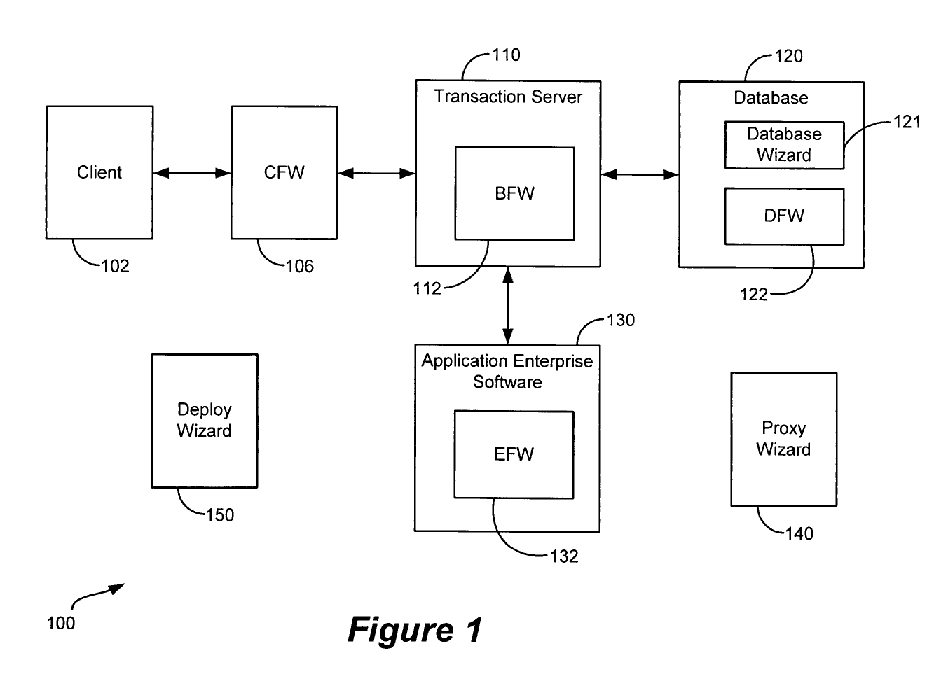

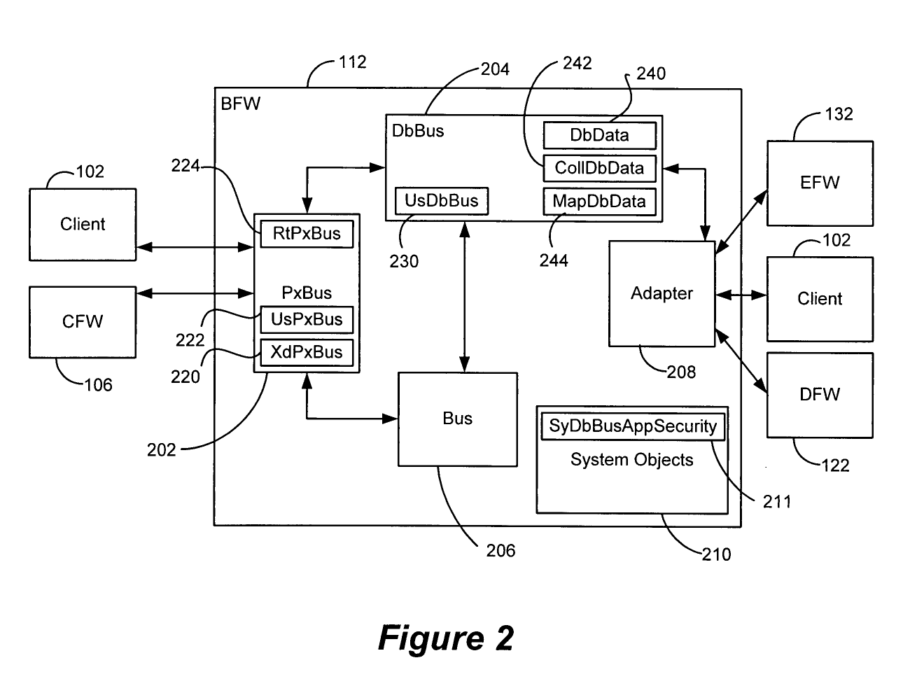

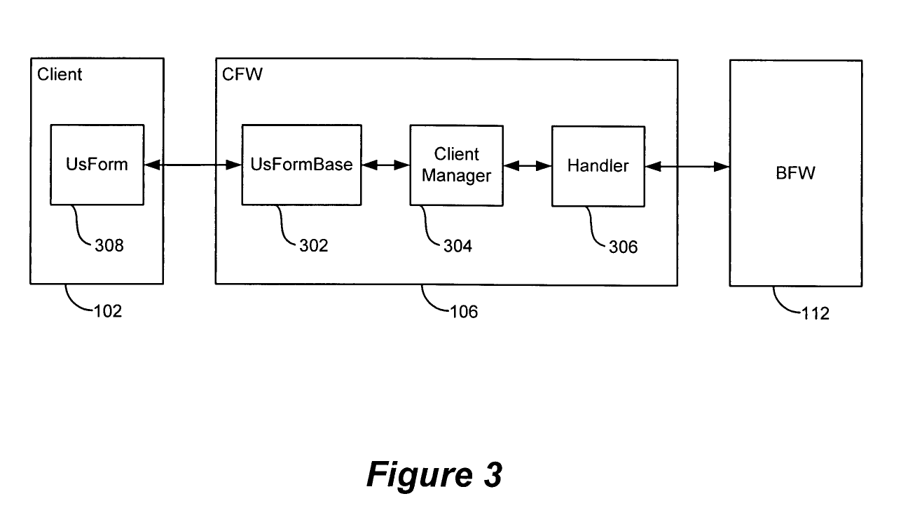

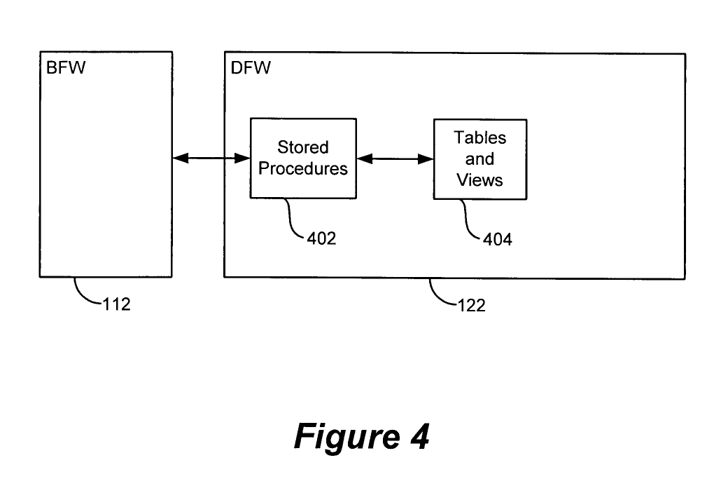

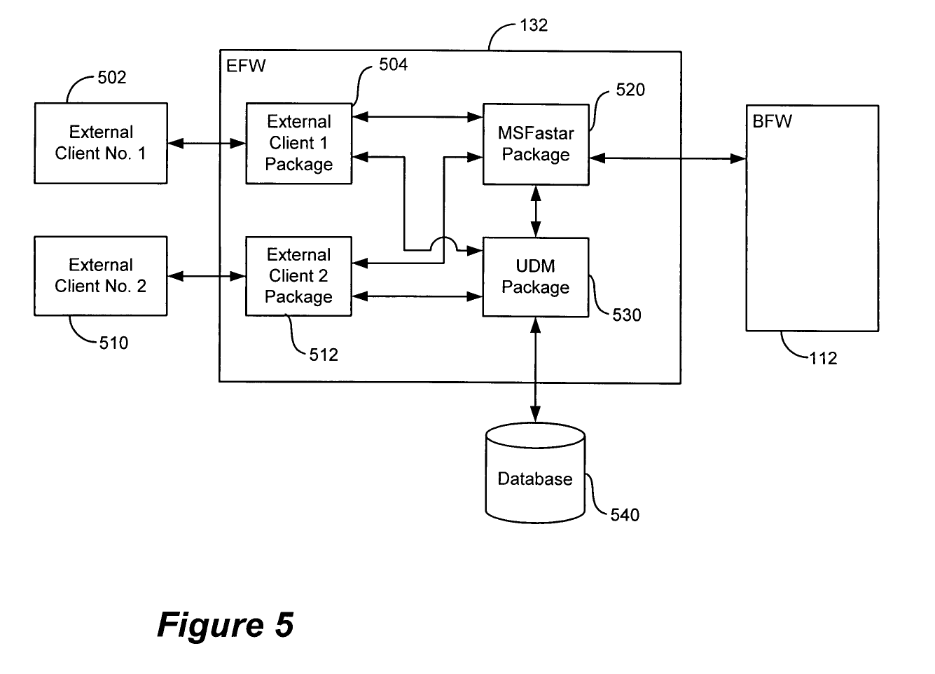

The present invention is directed to a framework for modeling multi-tiered enterprise applications. The multi-tiered enterprise applications so modeled can be used to manage an existing multi-tiered enterprise application, or the present invention may be used to optimize a new (potential) multi-tiered enterprise application. The present invention provides a RAD environment for generating high-performance software that is related to multi-tiered enterprise applications. As illustrated in FIG. 1, the present invention consists of a system 100 having four sub-frameworks: The business framework (“BFW”) 112 sub-framework provides supporting structure and services to business objects. The client framework (“CFW”) 106 sub-framework provides support structure and some services to the client forms. The services of the database framework (“DFW”) 122 sub-framework provide a bridge and design methodology between the database and business objects. The external framework (“EFW”) 132 is an enterprise application integration (“EAI”) that is a sub-framework that forms the template and provides services that enable the integration of other external vendor software into the system. To ease development and maintenance, a proxy wizard 140 and a deploy wizard 150 are included within the system 100. Each of these sub-frameworks is discussed in detail below. Specifically, the components of BFW 112 are further illustrated in FIG. 2. Likewise, the components of the CFW 106 are illustrated in FIG. 3; the components of the DFW 122 are illustrated in FIG. 4; and the components of the EFW 132 are illustrated in FIG. 5.

The Business Framework

The business framework (BFW) 112 provides services for business objects. The business objects themselves run within the BFW 112.

As illustrated in FIG. 2, the BFW 112 contains various proxies, such as the business proxy “PxBus” 202, the business database proxy “DbBus” 204, as well as the business objects themselves (“bus”) 206, and system components (such as the adapter 208). The PxBus objects 202 are business objects that are owned entirely by the BFW 112. PxBus 202 objects act as proxies that are capable of handling incoming calls, such as those generated by the CFW 106 or by clients 102. All clients, reports, and external software go through a proxy to get to other business objects. PxBus objects 202 are preferably generated by third-party tools, although third-party generation is not required. The DbBus objects 204 are proxies that are tied to a database table or a database view. A DbBus object 204 consists of three separate objects, such as the DbBus business object 204 itself, which is stateless; a DbData business object state 240; a CollDbData object 242 that is a collection of the business object state objects (DbData 240) and a map database data object “MapDbData” 244. The bus 206 is a business object that is not tied to a database schema. Instead, the bus 206 objects are manager or controller objects. Bus 206 business objects consist of a layer of non-generated code (such as BFW 112 base classes), and a layer of generated-if-not-existing code that can be generated by third-party tools. Once generated, the latter layer becomes non-BFW code and thereby enables business functionality to be added to the system.

The proxy for the present invention is an interface-specific object that packages parameters for that interface in preparation for a remote method call. Proxies are preferably included in their own respective sub-frameworks. Typically, the proxy runs in the address space of the sender and communicates with a corresponding stub in the receiver's address space. The PxBus objects 202 serve as proxies for the bus objects 206. In operation, once an external message (“call”) is received, the proxy forwards the call to a DbBus object 204 or bus 206 objects, depending upon the type of call. The DbBus 204 and bus 206 objects actually respond to the request, either alone or in conjunction with other business objects. Whenever a business object requires access to a database or to another application, it accesses it through one or more of the adapter 208 objects. For example, business objects can send or receive information to, for example, the EFW 132, the DFW 122, and/or clients 102, via the adapter 208 as illustrated in FIG. 2.

Ideally, the BFW 112 is object oriented, easy to support, open, reliable, transactional, high performance, secure, capable of handling ultra-large loads, security neutral, organized, protocol neutral, robust, data source neutral, simple, client neutral, RAD, transaction server neutral, and facilitates report integration. In the embodiment described herein, the BFW 112 follows the object-oriented methodology, although other methodologies can be used.

The BFW 112 can exist on one or more servers. Any business objects that are contained within the BFW 112, therefore, can also exist on one or more servers or on one or more clients. Each server can contain the entire BFW 112 and all the business components or each server can contain the entire BFW 112 and select business components. Communication between business components (and within the BFW 112 itself) has been optimized for this type of access. This is due to the fact that all business objects must be stateless. Because they are stateless, making multiple round-trips to do one task is impossible. Each task, therefore, requires exactly one round-trip. Because there are few round-trips, performance between business objects across the server is enhanced.

The BFW 112 provides supporting services that make it an open system. These include: email services; send messages services; and services to contact the EFW 132 and be contacted by the EFW 132. The EFW 132 is explained more thoroughly in a later section.

The present invention is transactional with or without being placed inside a transaction server. The transactional feature of the present invention allows developers to run the BFW 112 without engaging in the time-intensive activity of having to configure the present invention within a transaction server. When configured within a transaction server, however, the present invention will use the transaction services gained therein.

To enhance the security of the business objects, and thus the system as a whole, a special class of business objects, namely the proxies, is the only class that is exposed to the outside world. There are three types of proxies (as illustrated in FIG. 2), namely: the report proxy “RtPxBus” 224 (reports go through this proxy); the user proxy “UsPxBus” 222 (clients go through this proxy); and the external data proxy “XdPxBus” 220 (external Data goes through this proxy).

Business objects that are not proxies are secure from intrusion because they are not visible or accessible remotely, that is, they are not callable from outside the server from which they are installed and instantiated. In contrast, the proxies are the only objects that are visible remotely, and are consequently vulnerable to attack. However, within each method of each proxy is a special security check. Only if the security check succeeds will the method invocation be allowed to proceed.

Another interesting feature of the present invention is that the proxies are generated, instead of being hand-coded. Therefore, developer error cannot lead to security breaches. If the proxies were hand-coded, a developer could miss making a security check on a certain method. Because the proxies are generated, such a security lapse is not possible.

The present invention supports a plug-in capability for security. The present invention makes all security checks through a special business component called the system business database application security “SyDbBusAppSecurity” component 211 (which is generally part of the system objects 210 that is operative with the BFW 112, see FIG. 2). How this component implements security (via, for instance, LDAP) is immaterial to the present invention. The present invention simply knows how to deal with SyDbBusAppSecurity component 211 and, therefore, it is left to the SyDbBusAppSecurity component 211 to implement a particular vendor's security implementation.

In order for the present invention to support another vendor's security implementation, the SyDbBusAppSecurity component 211 must be written in a way that facilitates cooperation with that vendor's implementation. In this way, simply replacing one SyDbBusAppSecurity component 211 with another essentially changes how the present invention performs security checks. Moreover, the SyDbBusAppSecurity component 211 can support multiple security implementations (including protocols, conventions, and rules) simultaneously. Thus, the SyDbBusAppSecurity component 211 can provide multi-vendor support of security implementations.

The BFW 112 supports a plug-in protocol concept for out-bound communication. The plug-in protocol concept is preferably implemented with Adapters 208. All communication out of the present invention goes through an adapter 208. Each adapter 208 preferably implements the same interface.

Some business objects are tied, at generation-time, to an adapter 208. For example, if the business object is of the group “web methods,” then it will be tied to, for example, a SOAP-lingual adapter 208. If the business object is of other types, it will be tied to, for example, a database-lingual adapter 208. It should be noted that the adapters 208 are intended to be “pluggable” devices that are written for specific needs. Consequently, the group to which a business object belongs dictates which protocol (and data source) to which that business object is tied.

The coupling of groups to specific data sources has significant RAD benefits. A business developer can easily determine (simply by looking at the business object's group designation) where communications (such as signals or messages or the like) from business objects will go. This feature of the present invention enhances the ability to develop business models quickly.

Communication into the present invention is always directed, initially, to the proxies. The form of communication is preferably by direct method invocation, although alternate communication schemes are contemplated. For example, remote calls are first processed depending on their form. For instance, if the remote call is in the form of HTTP, then the remote call will be processed initially by a web server. That web server then translates the call to direct method invocation and calls the proxies. To that end, the BFW 112 includes web server extensions that perform this function.

As mentioned previously, all out-bound communication is routed through an adapter 208. The adapters 208 of the present invention are preferably conversant in Microsoft's ActiveX data objects (“ADO”), object database connectivity (“ODBC”), simple object access protocol (“SOAP”), and other protocols. Consequently, the particular adapter 208 that is used in a given communication instance will determine the form that the out-bound conversation will take. Communication with data sources, incidentally, is always out-bound from the BFW 112. The business objects only make outbound calls to the database 120 (see FIG. 1). However, the database 120 will preferably not make a call to a business object. This out-bound communication feature enables the present invention to talk to any data source, not only to its own data source. Moreover, the BFW 112 can talk to data sources that do not implement the DFW 122.

Any client can talk to the BFW 112 given that the client uses protocols implemented by the BFW 112. In this instance, the client is typically a software process that seeks to exploit the services of the BFW 112.

While the use of a transactional server is not essential, having the BFW 112 configured within a transaction server 110 allows the BFW 112 to gain distributed transaction support, security, and the other benefits that come from being within a transaction server 110 (see FIG. 1). The transaction server 110 preferably adheres to industry standard transaction processing that ensures that resources are not permanently updated unless all of the operations within the transaction complete successfully. By binding a set of related operations together into a transaction that either completely succeeds or completely fails, error recover is vastly simplified. Using transaction processing, the BFW 112 can operate almost entirely the same when not configured because its standard configuration would handle complete success or complete failure. Moreover, in the preferred embodiment, the same code is executed with the exception of a transaction manager component (that governs the mode of execution) whose responsibility is to detect when the BFW 112 is running outside of a transaction server 110 and, in which case, provide transactional support. The primary benefit of this capability is to allow developers to run the present invention without configuring it in a transaction server 110.

The BFW 112's transaction server 110 of the present invention contemplates functioning in one or more modes. The BFW 112 transaction server neutrality extends to its build mode. The BFW 112 executes the same code, whether in a development environment, adorned with debug information, or optimized for release. This arrangement allows errors in production to be faithfully reproduced in the development environment for easier identification and remedy.

The BFW 112 has an advanced error-handling system. The BFW 112 error-handling system not only catches errors in production operation, but also catches them in development. The error handling features include (but do not preclude) the ability to detect and to capture the entire call stack (with line numbers) of the error. Errors captured in the field can be written to any data store including a server's event log. If desired, the error can then be “stripped-down” before presentation to a user. Errors captured in development can be displayed to developers, preferably by use of a message box.

The error-handling system itself is easy to support. All errors flow through the same routine. By changing this routine one can change, for example, where errors are recorded and what information they display.

The present invention's error-handling feature is capable of capturing operating system errors by wrapping every method invocation in a special try/catch block. Consequently, some errors, such as COM errors, as well as operating system errors, both fall into the catch block where they are processed by the error-handling routine. In other words, in the preferred embodiment of the present invention, all errors flow through one error-handling routine. Optionally, the error-handling routine of the present invention builds call stack, line number information as an aid to debugging.

The framework of the present invention has additional development features. For example, if a developer happens to forget to wrap his method in a try/catch block, a compiler-error will be generated. Consequently, developers are encouraged to include try/catch blocks in every method, thus ensuring that all errors are handled by the error-handling system.

In addition to error-handling information, support teams also receive diagnostic and performance information from statistics that are generated by the transaction server 110 itself. Remember that every form has a corresponding proxy. Moreover, because every proxy is configured within the transaction server 110, support teams can see usage information on a per-form, per-report, and per-external data basis. The latter feature aids in the diagnosis of overall system usage and identifies bottlenecks.

The BFW 112 includes two key technologies that ensure reliability: structured exception handling; and clustering. As mentioned above, all of the method calls are typically wrapped in try/catch blocks. In fact, the compiler ensures that this is always the case. Structured exception handling is enforced by means of wrapping ‘try’ and ‘catch’ macros around the method invocations. A macro is a set of pre-defined instructions that are inserted at runtime. Structured exception handling causes all operating system failures to be passed to an error-handling routine. The error-handling routine then ensures that the error is passed all the way back to the user. Because the present invention implements structured exception handling, and uses try/catch blocks, all operating system errors and all normal COM errors are captured. Therefore, the present invention survives even disastrous failures. One particular note is that the present invention will survive disastrous errors even if the framework is unconfigured for a particular use. In other words, the particular directives for operation do not affect the ability of the framework to create a workable result. Consequently, developers will not crash the present invention, even while testing and/or debugging. When errors are encountered, the present invention returns a useful indication of the error, such as a displaying a call stack that may include line numbers.

If, perhaps due to hardware failure, the present invention fails, then another machine can take over. The machine failover feature is available because the present invention supports clustering of servers that support the software applications of the present invention. It should be noted that the present invention may also support protocols that do not support clustering.

The BFW 112 of the present invention is preferably a high performance sub-system. The BFW 112 preferably includes one or more of the following features: de-multiplexing (via UsDbBus 230); fewer round-trips (optimization); objects corresponding to a view; copy memory block record sets; the ability to conduct a get or save in one round-trip; and read-committed transaction mode capability.

The UsDbBus object 230 is a type of object that can be used for multiple functions. For example, in the context of a commodity function, the UsDbBus object 230 would take on the designation UsDbBusCommodity. For every form in the CFW 106, there is a corresponding business object that the form uses to communicate. That business object is called a UsDbBus object 230. The function of the UsDbBus object 230 is to ensure that the round-trips between the CFW 106 and the BFW 112 are accomplished as quickly and/or as efficiently as possible. Consequently, rather than a client making many round-trips to perform some action, the client would instead tell the UsDbBus object 230 (which is located on the server) to make the round-trips to perform that particular action. Because the UsDbBus object 230 is located on the server, and because the business components with which it must communicate are located on the server, the round-trips are local function calls and hence, may be accomplished more quickly and efficiently.

Having a primary UsDbBus object 230 for each form has a further benefit, namely, the cost of the round-trip to create a business object (and later discard it), as it is only incurred once per form.

UsDbBus objects 230 can be generated from database views. It should be remembered that these objects are only used by the client CFW 106. By allowing a UsDbBus object 230 to be associated with a view, the necessity of having to go through a business object to populate a form is alleviated, so forms can be populated directly by the UsDbBus object 230. Because the user cannot save to a view, the act of saving a form requires business object interaction. In contrast, loading a form may not require business object interaction.

The present invention facilitates single copy memory block record sets. When an adapter 208 is used in the present invention, it has preferably been optimized to allow returned database record sets to be copied into a business object's state object (e.g., DbData object 240) in one memory copy (memcpy) invocation.

The present invention enables one round-trip for get and save functions. When a user gets a record or saves his changes, that operation occurs in one round-trip. This is because the forms use a DbData object 240 (which is a composite object that may contain both objects and collections), and the DbData object information is all that needs to be sent to the server.

The BFW 112 is preferably designed to operate in the read-committed transaction mode. The read-committed transaction mode is very efficient and requires careful design. In the read-committed mode, the database holds only a few locks. The limited number of locks allows the database to operate well, even under heavy loads.

The BFW 112 includes certain characteristics that enable it to handle large loads. Those characteristics are scalability, load-balancing, and statelessness. With respect to scalability, business objects can exist on different servers. Communication between business objects has been optimized for this type of behavior. With respect to load-balancing, there are two types of load-balancing available, namely, static and dynamic. Static load-balancing is where a client, once connected to a server, must stay with that server until the user closes his application. The BFW 112 is intended to operate in this mode with clients using, for example, DCOM or another protocol. DCOM is a stateful protocol and does not support dynamic load-balancing. Dynamic load-balancing allows each method invocation to occur on a different server. Dynamic load-balancing is only supported by clients using SOAP. The BFW 112 supports either type of load-balancing because all business objects are stateless. Finally, with respect to statelessness, as mentioned earlier, the BFW 112 and all business components within it are stateless. The use of a stateless protocol allows the BFW 112 and associated business objects to handle loads well because they have very little synchronization.

There are many levels of organization within the BFW 112 as illustrated in FIG. 2. These levels of organization within the BFW 112 include the bus 206, the DbBus 204, business objects (that belong to groups), special groups, naming conventions, and derived objects. With respect to bus 206 and/or DbBus 204, a business object is either one of two types. Either it is a bus object 206 (that has no association with the database) or it is a DbBus object 204 (that does have an association with the database). Bus objects 206 are generally manager or controller objects. DbBus objects 204 are normally persisted objects.

Business objects belong to groups. A business object must belong to a group, preferably a two-letter group (co, nm, td, etc.). The group indicates the business category in which a business object belongs. For example, a contract business object can belong in the trading (Td) group.

With respect to “special groups”, some groups have special meaning to the BFW 112. Some examples of special groups are those that have, for example, the designation “us,” “rt,” “xd,” and “wm.” Business objects that elect to belong to one of the aforementioned groups gain certain behaviors, namely: “us” designated groups can be called directly by the CFW 106; “rt” designated groups can be called directly by a report; “xd” groups can be called directly by the EFW 132; and “wm” groups can call the EFW 132.

Naming conventions are formed from the Bus 206, DbBus 204 and group relationship. Examples would be CoDbBusCommodity, TdDbBusContract, and IvBusLocationScheduling. Any convention may be adopted, and the above examples are neither exhaustive, nor exclusive.

Derived objects include the name of their base class. For example, the DbBus 204 may inherit from bus 206; CoDbBus may inherit from the DbBus 204, and CoDbBusCommodity may inherit from CoDbBus. Again, the types of inheritance mentioned previously is not exhaustive, nor exclusive.

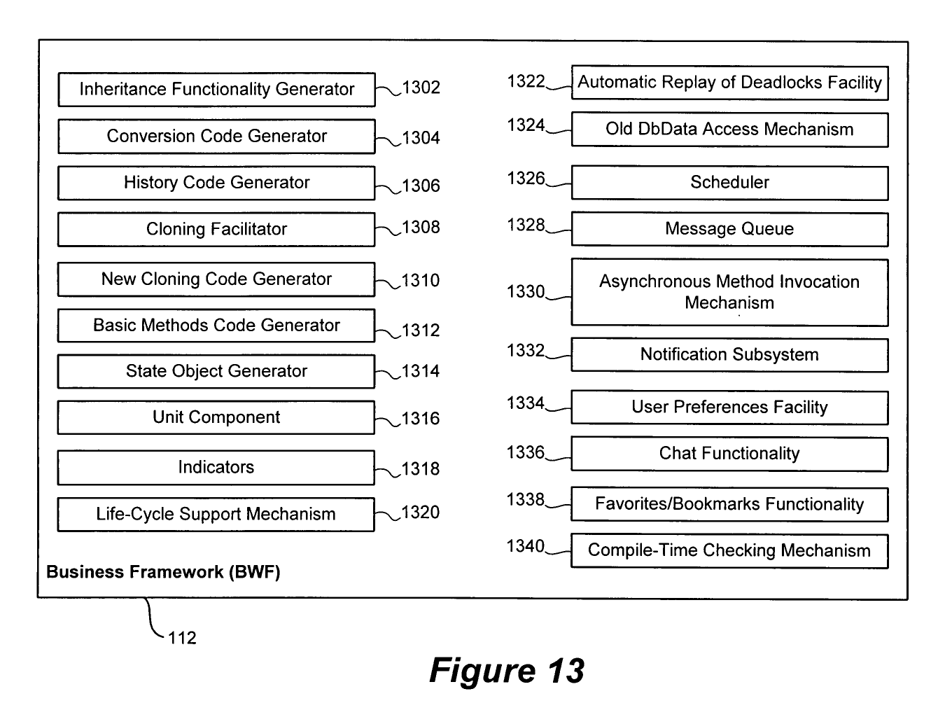

As shown in FIG. 13, the BFW 112 supports the following features: business objects can inherit from each other (through the inheritance functionality code generator 1302); business objects can convert to other business objects (with the conversion code generator 1304); automatic history is available (through the history code generator 1306); automatic cloning is facilitated (via the cloning facilitator 1308); automatic new cloning is available through the new cloning code generator 1310); automatic generation of “get” and “put” object methods (via the basic methods code generator 1312); support for primatives, automatically generated state objects (via the state object generator 1314); a unit component 1316 (explained below); indicators 1318; life-cycle support mechanism 1320; automatic replay of deadlocks facility 1322; old DbData access mechanism 1324; a scheduler 1326; a message queue 1328; asynchronous method invocation mechanism 1330; notification subsystem 1332; user preferences facility 1334; chat functionality 1336; favorites/bookmarks functionality 1338; and compile-time checking mechanism 1340. The above list, however, is neither exhaustive nor exclusive.

Business objects can inherit from each other. Business object inheritance in the context of the BFW 112 (via the inheritance functionality generator 1302) goes far beyond the simple concepts of traditional class inheritance commonly known in object-oriented programming. For example, assume that a vessel is a type of transport. A developer can establish a relationship between the type of transport and the database with a “Wizard-like” tool, namely database wizard 121 (see FIG. 1). The database wizard 121 is preferably an external, supporting tool that enables the described functionality, although the database wizard 121 can be subsumed within the present invention. The database wizard 121 can be as simple as a set of configuration scripts, or it can be a sophisticated GUI program, or anything in-between. Once the relationship is established, a business object of the transport type will be generated that contains all of the transport columns in the database, as well as all vessel fields (columns). Then any call made to create a vessel in the database will also create a transport in the database. The transport will contain a foreign key to the vessel in the event that a relational database is used, although other types of relationships, for example, object databases, can also be used with equal effect. The same is true for updating. Updating a vessel will update this transport's object. Deleting a vessel will delete the associated transport.

Business objects can convert to other business objects. In the database wizard 121, a developer can indicate that two (or more) business objects are related for some business purpose. When a business object is generated it will have one or more methods that enable it to return the other related business object(s) (or references or other identity information of those related business objects). The BFW 112, specifically the conversion code generator 1304, looks at all the columns in the database that the business objects contain. For columns that are the same (same name and type) between business objects, those columns are automatically copied between them. If the columns are different, they are not copied. A developer can always override this default behavior and perform a copy between different columns, for example, if desired. Performing conversion by comparing database columns has a positive side effect, developers are encouraged to give columns the same names and types if they perform the same function. Business objects that convert to other business objects are called tearoffs of that business object. Further, it is possible to establish a tearoff relationship such that when one business object is converted to another, only data that has changed in one business object is copied to the other.

Automatic history of objects is available. If the history request command is invoked in the database wizard 121, the database wizard 121 will modify the insert, update, and delete stored procedures for the business object via the history code generator 1306. Essentially, history will automatically be written as an object is modified. If a user wishes to see history, a stored procedure can return those parts he/she wishes to see and, if desired, the developer can override the BFW 112 default behavior for returning history and customizing it.

Automatic clone capability can be included within the framework via cloning facilitator 1308. When business objects are generated, they automatically receive the ability to create copies of themselves. Status flags are also cloned.

A feature called “automatic clone new” can be included within the framework in the new cloning code generator 1310. Business objects can also create a copy of themselves and the copy has a status flag of inserted in a feature (property) called “clone new.” The clone new feature allows a business object to insert multiple copies of the same record into the database. Each copy will have a different primary key or unique identifier.

The framework can automatically generate standard object functions such as “get” and “put” for getting and saving data within properties of the object with the basic methods code generator 1312. When a business object is generated with a database wizard 121, it automatically contains all the persisted data. Functions to get the data and functions to put the data are automatically created by the database wizard 121.

The framework of the present invention provides support for primitives. The database can also contain columns that include, but do not preclude, the following special types: primary key, calendar; units; DbIndicator; and binary file. The BFW 112 contains wrapper objects for each of these special types. These wrapper objects allow, for example, a calendar to add a day, or to allow a unit to convert from the English system to the metric system. When a business object is generated from a database table which contains one or more of these special types, the wrapper object is included in the business object, not in the raw type. Consequently, the unit object would be included in the business object and not, for example, two string types and a float type. The BFW 112 will then ensure that the two strings and a float are placed into the unit object.

The present invention can automatically generate state objects with the state object generator 1314. When a business object is generated from a database table or view, three objects are actually output: the business object (DbBus object 204); the business object state (DbData 240); and a collection of the business object state (CollDbData object 242). The DbData object 240 is an object that encapsulates specific data, and has specific functions that return results based upon the data of the business object DbBus 204. For example, AdderBus knows how to add parameters “A” and “B.” Then AdderBusData (the invocation of the DbBus object 204) is an object that can be instantiated with values such that AdderBusData.A=2 and AdderBusData.B=3, and AdderBus.Calculate(AdderBusData) will return 5. The CollDbDataXXX objects 242 are specialized container objects that hold sequential collections of DbDataXXX business object states, where “XXX” designates a particular version or application of those specific objects.

In the preferred embodiment, the CollDbData object 242 contains the business object's state in a linked list. Linked lists are most efficient at retrieving records sequentially. However, the choice is optional, and other types of schemes are available, in addition to link lists. For example, if a developer does not want to retrieve records sequentially, the function will instead be used for locating specific records, and then the developer may use a map (sometimes called a hash table). To select a map (or other function), the developer invokes the map command on the database wizard 121 and, in addition to a CollDbData object 242, a MapDbData object 244 will be generated. The MapDbData object 244 is a specialized container object that holds collections of DbData objects 240. The generated objects (DbBus 204, DbData 240, CollDbData 242, and MapDbData 244) all are generated in a fully functional configuration. However, a developer may wish to add custom functionality. For instance, he/she may want to add a custom property to DbData object 240. The generated code is all placed in a separate folder on, e.g., a file system, and consists of base class files. The DbData 240, CollDbData 242, MapDbData 244, and DbBus 204 objects inherit from their respective base class files. The base class files cannot be modified by a developer because the developer's modifications will be overwritten upon the next build. However, the derived DbData object 240 (and other objects) can be overwritten by a developer.

The BFW 112 includes a powerful unit component 1316. The ability to convert data to a specified unit of measure allows the user to view data in the most convenient form. In addition, the flexible method for defining supported unit formats allows the system to expand in the future, often without the need to implement new code. The developer is presented with a set of high-level tools to perform numeric computations quickly, while remaining insulated from the associated internal complexities. This allows for efficient development of business objects while reducing maintenance requirements.

The BFW 112 can also provide indicators 1318. In some cases, developers want to work with an enumerated type. However, enumerated types are not supported in the database. Therefore, the developer users a special user-defined type for the database column. The database wizard 121 observes that a special user-defined type is used in the database column, and then uses an enumerated type in the DbData object 240. The BFW 112 will then convert the user-defined type to the enumerated type at bind-time.

The present invention also provides life-cycle support via the life-cycle support mechanism 1320, as illustrated in FIG. 13. Each DbBus 204 object has a life cycle. The BFW 112 notifies the DbBus 204 as life-cycle events occur. To facilitate this feature, various functions are provided, including PreCreate, PostCreate, PreSave, PostSave, PreDelete, and PostDelete. The PreCreate function is called before a DbBus object 204 and a DbData object 240 are created in the database. The DbBus 204 object can halt creation by returning an error. The PostCreate function is called after the DbBus object 204 and the DbData object 240 are created successfully in the database. The PreSave function is called before a DbBus object 204 and a DbData object 240 are updated in the database. The DbBus 204 can halt the update by returning an error. The PostSave function is called after the DbBus object 204 and DbData object 240 have been updated successfully in the database. The PreDelete function called before a DbBus object 204 and a DbData object 240 are deleted from the database. The DbBus object 204 can halt the delete by returning an error. The PostDelete function is called after the DbBus object 204 and the DbData object have been deleted successfully from the database.

The present invention enables automatic replay of deadlocks via the automatic replay deadlocks facility 1322. The BFW 112 is transactional. However, sometimes a transaction fails with a special error, e.g., deadlock. This error indicates that the database locks on the table, preventing the table from being modified. When the BFW 112 detects such an error, the BFW 112 replays the transaction a specified number of times with a specified delay interval between attempts. This replay tactic allows the database to clear its locks. The users and business objects are unaware of the deadlocks as the BFW 112 performs this deadlock replay transparently. The specified number and delay interval may be pre-defined or may be calculated dynamically.

Sometimes business objects need to know how they have changed over time. The BFW 112 preferably includes status flags for each value over time. However, these status flags just indicate that a value changed. The status flag does not indicate what the previous value was. To determine previous values, the present invention allows a developer to select an “Old DbData” command on the database wizard 121. When the Old DbData command is invoked, the DbData object 240 that is generated contains another DbData object 240 via the old DbData access mechanism 1324 which can impart the status flags. This other DbData object 240 is of the same type as the original DbData object 240. However, the other DbData object 240 contains the state of the DbData object 240 before the change was made. After an order to create or to update has been issued, the old DbData 240 will be updated with the changed values.

Certain business objects need to perform tasks at regular intervals. The BFW 112 preferably includes a scheduler component 1326. When the scheduling component 1326 is started, it “looks” in a special table within the database called the schedule table. The scheduling table contains the name of the business object to invoke to perform the task, and the frequency of invocation.

Developers may wish to invoke a business object such that the invocation is asynchronous, scheduled to occur immediately or at a particular date and time, guaranteed to occur even in the event of server failure, or for other reasons characteristic of a robust message queue system 1328. The message queue 1328 stores messages in the database. At regular intervals the messages are dispatched. Logs are kept to keep track of the status of messages. Further, purge logs are also kept which hold old log entries.

The BFW 112 also enables asynchronous method invocation via the asynchronous method invocation mechanism 1330. Sometimes it is desirable for one business object to invoke another asynchronously. A developer can elect this feature for a business object(s) by checking a checkbox in the database wizard 121. When the checkbox is set, an asynchronous proxy will be created which “wraps” the business object. The developer then invokes the asynchronous proxy instead of the business object. The asynchronous proxy will, in turn, invoke the business object (asynchronously). The developer could, of course, still invoke the business object synchronously. The asynchronous proxy allows asynchronous method invocation to be available in development (where components are unconfigured) or in the field. The asynchronously proxy also ensures that transactional requirements are met. Asynchronous method invocation differentiates itself from the asynchronous feature of the message queue (above) in that it allows for higher performance asynchronous method invocation.

The BFW 112 also has a notification subsystem 1332. The BFW 112 also includes system objects 210 (see FIG. 2) that allow any business object to send notifications to users in the form of email, facsimile, pager signals, etc. These system objects 210 are actually special business objects called framework business objects.

The BFW 112 also allows for particular user preferences facility 1334. When users manipulate their graphical user interface (“GUI”), there is a multitude of settings, which are specific to the user that the user generally desires to keep the settings persistent for future use. For example, if the user decides to hide a column in the grid, then the next time the user starts the present invention, it is presumed to want to see the grid column hidden. A framework business object, called, for example, the SyDbBusPreferences, performs these functions as generated by the user preferences facility 1334.

The BFW 112 can also include a chat feature 1336. Users also want to be able to chat with each other. The BFW 112 tracks all of the users on the system of the present invention and what form of communication they are currently using. There is a special framework business object, called, for example, the SyDbBusChatLog, that can list all of the users who are using the chat feature. The SyDbBusChatLog object also has the ability to let users belong to certain chat rooms.

The BFW 112 also enables the creation and retention of bookmarks and “favorites” via the favorites/bookmarks functionality 1338. Users can invoke a form and populate bookmarks and favorites with data. The user may then save the form as a favorite or default set of data. The next time that the user works on a form, he/she can recall the favorite form. This will cause a merge to occur between the items changed on the form and the items (data) stored in the favorite. This feature is particularly useful for reducing workload in repetitive situations. In the preferred embodiment, the user's “favorite” settings are stored as part of that user's profile in the application database.

The BFW 112 also enables compile-time checking via the compile-time checking mechanism 1340. In the preferred embodiment of the present invention, the BFW 112, via the compile-time checking mechanism 1340, ensures that there is compile-time checking throughout. To that end, individual objects, such as the CollDbData object 242 and the MapDbData objects 244 are provided for each business object. Is it preferable to have separate CollDbData object 242 and MapDbData object 244 for each business object 206. While the present invention is capable of providing a generic object that can be used by all business objects 206, this arrangement is discouraged. First, if a single CollDbData object 242 and a single MapDbData object 244 were used, the present invention would lose compile-time checking. It is best to ensure that one business object is not passed to another business object of the wrong type and such assurance is provided by compile-time checking. Consequently, a separate CollDbData object 242 and MapDbData object 244 are provided for each business object 206. Moreover, routines are devised to take the derived DbData 240 always. All DbData objects 240 implement their interface. The DbData interface 240 ultimately inherits from a class that is the base interface. No non-framework routines inherit from base interfaces. This means that the developer must pass the correct interface into a routine, and this technique reduces the number of potential errors. Use of this technique also implies that business objects are generated with routines that take their signatures. An example would be the IDbDataXXX.Clone( ) routine, which makes an identical copy of the object in memory, recursively copying any embedded objects as well. Compile-time checking precludes the need and/or desirability of routines that return a generic class variable typecast as a generic (base class) object. Such a typecast would be a common workaround in systems that do not have such object capability. Consequently, in the preferred embodiment, the database wizard 121 generates routines that take as parameters, wherever possible, the derived interfaces.

Business objects see the framework they reside in as a black-box or as a complete environment. The business objects are abstracted from the framework by inheritance and tools. Business objects inherit from specific framework base classes that give them certain functionality and tools, such as the database wizard 121 provides abstraction.

The BFW 112 supports RAD features such as generation of database business objects, generation of bus objects, globally unique identifier, (“GUID”) reuse, tearoffs, source control, automatic history of objects, consistent naming conventions, generation of XSD files, and easy enhancements, among other possible features.

Database Business objects (DbBus 204, DbData 240, CollDbData 242, and optionally the MapDbData 244) are generated from tables and views in the database 120. Each business object component inherits from a generated base class. Base classes are generated by the database wizard 121 based on framework definitions of common functionality. These generated base classes are placed in a special folder on the file system. Each business object has one such folder. When a business object is generated, its generated base classes will be overwritten, even if the base class existed previously. The business object components are derived business objects that may, for example, constitute COM components. The business object components themselves are also generated by the present invention. However, unlike the generated base class, the business object components are only generated if they previously did not exist. This difference is because developers are empowered to overwrite the business objects' class definitions. When developers perform a build operation, the database wizard 121 is executed as the first part of the build step. The developer will overwrite all of the generated base class files (and derived files if not present). The overwriting process allows compile-time checking of database schema. For instance, if a database table has a column called volume, when the business object is generated for this table, the DbData object 240 will have a method called get_Volume and put_Volume. Other business objects then use those methods. If the database table changes by the deletion of a column, then on subsequent regeneration, the base class will be missing the get_Volume and put_Volume methods that were associated with the deleted column. The other business objects that used this method will thereafter not find those methods. Consequently, the compilation of those business objects will fail because they reference methods that do not exist. In fact, having the software fail to compile would be the ideal result. However, generated DbBus objects 204 are fully functional in their default configuration and will compile. All project files are generated as well. Thereafter, a developer need only create a table and then, after generating objects based on the new table structure, other business objects can modify the table via the generated business object methodology. Bus (business) objects are also generated, as are their associated project files.

The database wizard 121 keeps a track of all GUID that are used by the business objects. Consequently, the same business object that is generated twice will use the same GUID. In other words, once generated, a business object will retain the same identifier, regardless of the number of times it is compiled.

Business objects in the framework of the present invention have the ability to convert (tearoff) from one object type to another object type. For each object type, the framework generates conversion code when the object is created, so that developers are relieved of the need to write the code that performs the object-type conversion.

The present invention also facilitates source control. Because all of the base class files and the derived files are generated, the developer only needs to place files in Source control if the developer has changed them. This means that the developer does not have to worry about checking in or checking out generated files. This feature also minimizes the number of files kept within Source control. This feature is useful for developers who work from remote locations and who have slow network performance because it keeps fetch time to a minimum.

Business objects get, at their option, automatic history functionality. By selecting a checkbox in the database wizard 121, the history table will be updated whenever the business object is modified.

Having consistent naming conventions has RAD numerous benefits for the present invention. Consistent naming conventions makes the code simpler and easier to understand. Naming conventions are enforced throughout the BFW 112. Naming conventions are also enforced via the tool sets, which could include: the database wizard 121, a proxy wizard, and a deploy wizard (the latter two are not shown). Database tables, views, and stored procedures must be named consistently. In addition, HTML pages and form names must also be made consistent. Finally, business object names and their associated directory structures also must be consistent.

The BFW 112 is preferably constructed and arranged to support protocols such as, for example, simple object access protocol (“SOAP”). To implement this feature, the business object schemas need to be expressed in, for example, an XSD. This expression is provided automatically via the database wizard 121.

A further benefit of the BFW 112 is that framework changes are abstracted from the business objects themselves for easy enhancement. Recall that the business objects inherit from generated base classes. Consequently, by changing the way that the base classes are generated can make a corresponding change to a business object. For example, changes to the base class may give objects more features, such as cloning.

The BFW 112 maintains a special group of business objects called “Rt” that can be used by a reporting system. By convention, business objects that begin with the Rt designation are only used by reports, although other conventions may be adopted.

When users look at a report, it generally involves looking at database data. Therefore, Rt business objects are associated with database views. When Rt business objects are generated, the database wizard 121 will generate not only the business object, but will generate a storable file as well. The storable file allows integration with third party reporting software, such as CRYSTAL REPORTS®. The file can instruct a report application, such as CRYSTAL REPORTS®, of the format of the data.

Another benefit of associating an Rt business object with a database view is that the report does not need to go to a business object to get data. Instead, the report can go directly to the database view to get (retrieve) it. Consequently, since the double-hop is not needed, overall system performance is enhanced.

The Client Framework

The client framework (“CFW”) 106 provides the support services needed to build a rich client application, or a web-based application, or other application that can be utilized by a client device. Developers for client applications build HTML pages and form objects for specific problems. Each HTML page can contain one or more CFW 106 controls (not shown). Each of these controls exposes properties that client application developers set. Changing a property via one of the controls changes default form behavior.

The form objects contain specific form behavior, such as what actions to perform in response to non-generic user activity like submission of a complex set of input data for a particular query. The specific form behavior is behavior that is not provided automatically by the CFW 106. Instead, the form objects interact with the CFW 106 via a special CFW 106 class, UsFormBase 302, as illustrated in FIG. 3. Referring to FIG. 3, the UsFormBase 302 class is the base class of all forms. Its purpose is to keep each individual form as simple as possible. The client manager component 304 (see FIG. 3) provides browser-independence capability. Therefore, the client manager component 304 performs functionality that is specific to the client's browser (such as turning menu items on and off). Any outbound communication goes through the handler 306. The handler 306 then passes the communication to the BFW 112.

As outlined below, the CFW 106 preferably is protocol neutral; organized; browser neutral; robust (flexible); easy to support; simple; reliable; RAD; and/or high performance.

All outbound conversation from the CFW 106 goes through one component, namely, the Handler 306. During an outbound conversation, the Handler 306 decides which protocol to use for the outbound conversation. By replacing the Handler 306, the user can change the outbound conversation protocol. This modularization is a key to the maintainability and longevity of the present invention. The Handler 306 can also be used to make protocols more efficient. Because the Handler 306 is specific to the protocol, it can optimize the protocol for the CFW 106. For instance, protocols can be employed that cache items, or prevent unnecessary round-trips, that enhance the performance of the present invention.

The CFW 106 does not require a specific browser. While web browsers are ubiquitous, there are many different browsers, and their behavior and capabilities vary greatly. The present invention accommodates the disparity in browsers by employing a browser-abstraction layer, namely, the client manager 304 (see FIG. 3). The client manager 304 is the only component that is browser-specific. Replacing one specific client manager 304 with another allows the CFW 106 to run in other browsers. The reason that individual forms are not affected by browser specifics is that the forms interact with the CFW 106. It should be noted that the CFW 106 provides a pre-defined life-cycle to the forms. The client browsers do not affect the life-cycle of the forms. If the forms need to perform some function, such as to disable a menu, they ask the browser-specific component to perform that task. The CFW 106 then interacts with the browser to accomplish the task.

Just as the BFW 112 generates a call stack, so does the CFW 106. The CFW 106 has its own error-handling system that appends call stack information. If the error is from a business object operating on the BFW 112, that error will contain call stack information. The CFW 106 then appends his own call stack information to the error. When the developer subsequently reviews the error message, the developer will see the entire call stack all the way from the business object and through the client.

Just as the BFW 112 uses try/catch blocks in each method, so does the CFW 106. This ensures that all errors flow through the error-handling routine of the present invention.

The CFW 106 was designed to have high performance. Therefore, the CFW 106 preferably includes the following features: client-side cache; asynchronous server invocation; asynchronous downloading; “lightweight” components; and use of a single copy of the DbData object. The client side cache retains collections that have been downloaded. Rather than fetch a collection again, the system can retrieve the collection from the cache. In practice, this retrieval may be difficult. When a form is invoked, one round-trip is incurred. A round-trip involves loading all of the GUI widgets, such as comboboxes, grids, etc. Only if all of these collections are already in the cache will the round-trip not incur. When a combobox is selected, other comboboxes may need to be populated based upon the user's selection in the first combobox. The later selection thus incurs a round-trip. Of course, this later round-trip flows through the cache as well. The cache is more effective here as this round-trip is just to retrieve one collection. If that collection is already in the cache, the trip is not incurred. To further reduce round-trips, the cache can be saved and loaded from a persistence mechanism such as a file or database.

The CFW 106 and client forms have the option of calling the server asynchronously. By invoking a method or an asynchronous handler, the CFW 106 or client form can achieve an asynchronous call. The out values from the call are sent to the CFW 106 or client form via an interface.

The CFW 106 can asynchronously download its constituent components in the background. After a user starts the application, the application detects components that are missing or have been updated. It then prioritizes the missing components based on user usage information and begins downloading those missing or updated components. If a user navigates to a form before that form's constituent components have been downloaded the user must, of course, wait for those components to be downloaded.

The CFW 106 is intended to be a web-based application. However, other applications architectures, such as traditional client-server applications, are possible with the present invention. As web-based applications are preferred, it is advisable to keep many of the components small (lightweight) for easy transport over busy networks. The sizes of the binaries that comprise the application are, preferably, very small. To achieve smaller binaries, the CollDbData module object 242 should have a linked list. This linked list is not directly compiled into each CollDbData object 242. Instead, there is a separate object that is generic to all CollDbData objects 242 that are derived from, or are of type CollDbData. The CollDbData module object 242 contains the linked list and functions for accessing/modifying it. This allows each individual CollDbData object 242 to be as small as possible. What is true for the CollDbData object 242 is similarly true for the MapDbData objects 244. While the map is not in each MapDbData object 244, it is in a generic companion object. To further reduce the size of the CFW 106, each UsForm 308 on the client 102 uses a generic base class. This generic base class contains much of the functionality needed by the form, especially in relation to communicating with the CFW 106. This configuration enables each individual form to be kept small (light) and thus quickly transportable over busy networks. Finally, each UsControls also uses a generic base class to keep each control lightweight. Of course, an added side-benefit is reduced build time.

The CFW 106 uses a single copy of the DbData object 240. The data contained on a form is from a DbData object 240. The controls load themselves from this DbData object 240 after a user performs, e.g., a “get” command, and the controls save themselves into the DbData object 240 when the user saves his/her work. The same DbData object 240 goes back to a server and is used by the server. Consequently, no copying is needed between the client 102 and the server. The same data object is reused between the two. The server in this instance can be a generic server, such as an application server, or even the transaction server 110. Transaction services may be executed on a battery of physical servers. However, the database service may execute on the same physical server as the transaction server 110.

Naming conventions are enforced on the client. Developers use the client tab of the database wizard 121 to generate UsForm 308 classes. The database wizard 121 enforces a naming convention for the form and for the HTML page on which the form resides. Typically, coding behind a GUI widget control is used to enforce the naming convention, although the form data can be passed through a special filter to determine the input data's suitability or adherence to convention, and if necessary, to return suggestions or notifications regarding infractions of the convention. Only HTML pages that follow the naming conventions can be brought up by the developer.

The CFW 106 contains many ways for developers to do their work. For example, the UsForm 306 receives messages first. Each UsForm 306 uses a base class, namely, UsFormBase 302 (see FIG. 3). However, all life-cycle notifications flow through the UsForm 306 first. The UsForm 306 then decides whether to pass the event to its base, UsFormBase 302. Through this life-cycle notification methodology, a UsForm 306 could effectively remove itself from a property-driven nature if so desired.

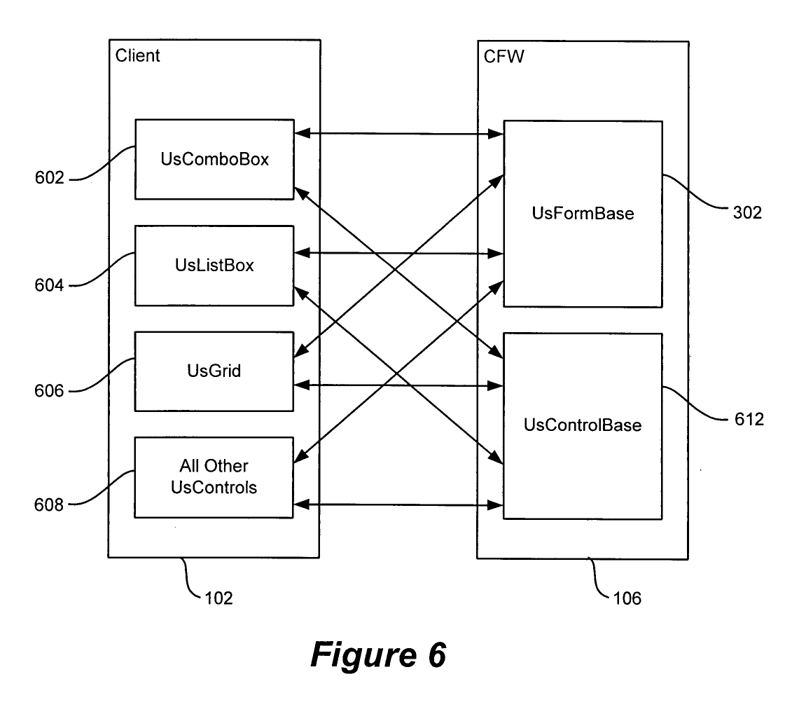

In the CFW 106, controls receive messages first. Controls are structured similarly to the UsForms 306. For instance, in the preferred embodiment of the present invention, controls have a UsControlBase 612, as illustrated in FIG. 6. Notifications flow first through the derived control, which can then choose whether to pass the notification on to the respective base.

Each form receives life-cycle notifications from the CFW 106. Example life-cycle notifications (events) include pre-initialize, initialize, initial load, get form, load form, save form, and terminate. The pre-initialize event is called the first time that a form is activated. If a user leaves the form and then comes back, the pre-initialize notification will not be called. The initialize event is called whenever a form becomes active. The initial load event is called when a form needs to load the backdrops of any GUI widgets, such as comboboxes, listboxes, etc. The get form event is called when the get command is invoked. The load form event is called when the form is to be loaded from, e.g., memory or a mass storage device. The save form event is called when the save command is invoked. The “terminate” event is called when the form is destroyed.

An HTML page is stateless. That is, if one retrieves an HTML page, and makes a subsequent request for that file, the previous copy of the file (and all attendant changes to form, are destroyed (as is the UsForm 306). The CFW 106 allows the state of an HTML page to be persisted. Again, a UsForm 306 contains all of the data on the form. Therefore, if the HTML page is persisted and then reloaded, the form will have the same input information. The UsForm 306 does this by implementing a persistent interface. When the user navigates off the form, the CFW 106 will tell the form to save itself into a passed stream object. When the user returns to the form, the CFW 106 will tell the form to load itself from that stream object.

The CFW 106 uses the same primitives as the BFW 112. These primitives include Calendar, PrimaryKey, units, etc. Therefore, methods such as “add a day” are also available to forms. Each DbData object 240 has a status flag. The status flag indicates whether the DbData is a brand new object, an unchanged object, an object to be deleted, or an object that has changed. The status flag is set automatically by the CFW 106 when the user invokes a command, such as “new,” “delete,” “save,” etc. After invoking a command, the client developer needs to do nothing further to obtain this functionality. When a DbData object 240 travels back to the business objects on the application server, the UsDbBus object 230 can look at the status flag to determine what should be done. For instance, if the flag indicated (has the value) “DELETED”, the UsDbBus 230 will delete the object from the database 120. There is a helper function to further assist this task that is called “Process.” When the Process routine is passed a collection of DbData objects 240, the Process routine will look at the status flag of each DbData object 240. The Process routine will then perform the proper operation (e.g., insert into the database, update the database, etc.) on the DbData object 240, given the value of its status flag. The Process routine is generated and is thus available to any developer who wishes to use it.

Client developers can treat the client framework as a black-box. The developer does not need to understand how the CFW 106 implements the property-driven system. The developer simply needs to know what the properties are. The same is true for the two important base classes, UsFormBase 302 and UsControlBase 612. The developer simply calls the appropriate method contained therein, and the proper framework is created. As illustrated in FIG. 6, the UsFormBase 302 and the UsControlBase 612 of the CFW 106 interoperate with various graphical user interface (“GUI”) widgets, such as, for example, UsComboBox 602, UsListBox 604, UsGrid 606, and all other UsControls 608 of the client 102.

The CFW 106 contains many RAD features. For example, there is reuse of code between client and business objects and, for example, the dbdata, colldbdata, and mapdbdata components (among others).

Client properties are probably the most important RAD feature. Again, HTML pages contain controls. Each control contains properties. The setting of these properties indicate the behavior of the form. So, if a user wanted a GUI widget (e.g. a combobox) to display locations, the developer would simply indicate so in the corresponding property of that GUI widget. Some properties include get, load, and save. When the get command is invoked, one would look at all of the controls that are “get” participants (another property). If the controls are part of the “get” participants, then their user-selected value is sent as part of the “get” request. After a get command is invoked, a DbData object is returned. The controls that are loaded from the DbData object, and how those controls are loaded, is specified in the control's load properties. When the save command is invoked, a DbData object will go to the server. The DbData object goes to the server by first finding all of the controls that are “save” participants, then the DbData object is then populated with their selected value.

Client forms are generated by the database wizard 121. The database wizard 121 ensures that the client forms are neat and commented. The database wizard 121 also ensures that, for example, the HTML page includes the client form. Incidentally, the database wizard 121 can also generate dialogs. The dialogs are also added to, for example, the HTML pages that make up the client forms.

The CFW 106 has numerous GUI widget controls that developers can use. The GUI widgets include: the combobox, the list box, the grid, the tab, the UsDialogButton, and the UsGetButton. Invocation of the UsDialogButton brings up a dialog box or page. The UsDialogButton exposes a property where users can enter the name of the dialog HTML page that it will bring up. The UsGetButton performs a “get” function when invoked. The UseGetButton can include properties that dictate how to perform the “get” function.

The CFW 106 and the rest of the present invention are automatically deployed by the deploy wizard (not shown). Developers do not have to contend with the details of deployment. The deploy wizard will package all the files and even perform a binary compare to keep versions updated.

The Database Framework

Referring to FIG. 4, the Database Framework (“DFW”) 122 may be composed of tables and/or views 404, and stored procedures 402, operating in, for example, SQL SERVER 2000® manufactured by Microsoft Corporation. In its present embodiment, there are no triggers needed for the implementation of the DFW 122. The preferred access to the DFW 122 is through stored procedures 402, although other access points are possible. These stored procedures 402 will then perform the appropriate actions on the database tables and views 404. The DFW 122 is easy to support, high performance, robust, simple, secure, RAD, and organized.

Clients 102 and business objects do not directly access database tables and views 404. Recall that only the DbBus objects 204 can access the DFW 122 via adapter 208 (see FIG. 2). Instead, the clients 102 and business objects always access stored procedures 402 that are tied to database tables and views 404. These stored procedures 402, therefore, provide a level of abstraction that can be exploited for additional functionality and ease of maintenance. For example, the underlying schema could change and, if the stored procedure 402 can be adapted, the client 102 or business object does not need to change. Similarly, clients 102 do not use business objects that are generated from database tables 404. Instead, clients 102 use business objects (e.g., UsDbBus object 230) that are generated from database views 404. The framework of the present invention provides another level of abstraction between the clients 102 and the database schema. Database schema, therefore, could change without need for changing the clients 102 or the UsDbBus business objects 230.

All access to and from the database 120 goes through one or more stored procedures 402. As a result, rather then send long structured query language (“SQL”) statements to the database, the business objects invoke stored procedures. Consequently, the network traffic between the business server and the database server is reduced. Further, the stored procedures are precompiled to enhance performance. If the business server had sent SQL to the database, then the database would need to build a binary tree of tokens in order to determine what action to perform. As stored procedures are already parsed, they are more efficient.

If a developer desires the history of a business object to be updated whenever the business object changes, that work is done in a stored procedure. To obtain a history, the business object tells the stored procedure to perform a specific action. The stored procedure will then update the history, if appropriate. In this way, the business object needs only make one call (one round-trip) to the database 120. If the stored procedure did not update the history, then the business object would have to invoke another stored procedure (two round-trips) to accomplish this task.

Whenever database tables are updated, a timestamp is checked. The timestamp check ensures that the database table is protected from simultaneous access. An example: two users A and B had the same form activated, were both looking at the same data, and user A changed his form and saved the changes. Once the changes were saved, user B's data is stale. User B may make a second set of changes on the form with the stale data, not realizing that that set of data is now stale. If user B attempts to save the second set of modifications, then user B could potentially overwrite the first set of changes. To alleviate that problem, the DFW 122 of present invention compares the timestamp of the existing (previously updated) data with the timestamp of the data on the form. If the timestamps do not match, then another user has modified the data and an error is issued. Timestamp checking is “free” and transparent for developers, and is built into the framework of the present invention.

In the preferred secure configuration, no external clients 502, 510 (see FIG. 5) access the database 120 directly, nor do the CFW 106 or the EFW 132 access the database 120 directly. Each of the above components accesses the database 120 via the BFW 112. This arrangement means that the database 120 can be isolated on the network, such as a local area network (“LAN”). The database 120 only needs to be able to talk to the BFW 112. Consequently, it is preferable to ensure that the BFW 112 is protected from security breaches.

For each table in the database 120, there are the following mandatory stored procedures: table insert (insert a new row into the table); table update (update a row in the table); and table delete (delete a row from the table). For each table or view in the database, these additional stored procedures are optional: table list by all (return all the rows from the table or view); table get by primary key (return one row from the table or view.) If the row is not found or multiple rows are found, an exception will be issued; table list by query (return zero or more rows from the table or view based on the query); table get by query (return one row from the table or view based on the query.) If the row is not found or multiple rows are found, an exception will be issued. It should be noted that table is a placeholder name. For example, if the table is the commodity table, then the stored procedures would be named pr_Commodity_Insert, pr_Commodity_ListByAll, etc. Moreover, Query is another placeholder name. For example, pr_Table_ListByQuery could expand to one or more of the following: pr_Table_ListByDate, pr_Table_ListByName, etc.

By the convention of this illustrative embodiment, views in the database must begin with the letters, Vw. In addition, if the view is of a special type, that is, if it is a view used by client, report, or an external source, then the view must have the following prefix: UsVwView (view used by the client); RtVwView (view used by reports); and XdVwView (view used by an external source). As with Table and Query, View is a placeholder name. For example, a name for a particular view could be “UsVwAdminCommodity.” In addition, if a view is used indirectly by a client, report, or external source, Util is added to the prefix. In that case, the prefix would be: UsVwUtilView (view used indirectly by a client); RtVwUtilView (view used indirectly by a report); and XdVwUtilView (view used indirectly by an external source).

According to the present invention, the DFW 122 provides developers certain aids and features, including, but not limited to, history and timestamp checking.

Database tables and views may have a primary key. If the database table or view has a primary key, then the primary key parameter must be one column and it must be called “yOid.” In addition, the primary key parameter must have two other columns called UserName and TimeStamp for a total of three columns, one of which is the primary key. This primary key parameter structure is mandatory for the preferred embodiment of the present invention and is enforced by the database wizard 121. Alternate embodiments, however, may not be constrained in the choice of primary keys.

It is possible to implement user-defined types within the database 120 of the present invention. Whenever a developer wants a table or a view to have units, indicators, or other primitives, the developer uses one of these user-defined types. If the developer does not want such indicators, then the code generated from the table, or the view will be incorrect and not work properly. Therefore, the developer is given no choice but to use the user-defined types. When other developers examine the database schema, they can easily understand it because of the enforced use of user-defined types. In other words, developers must use user-defined types in the database schema when they need primitives. This results in the database schema being easier to understand because the entire database schema is uniform.

The database wizard 121 generates the insert, update, delete, GetByPrimaryKey (optional), and ListByAll (optional) stored procedures. Consequently, the developer does not need to write or maintain these procedures. If the database schema changes, the developer only needs to regenerate the business object (which must be done in any case for the BFW 112). The regeneration of the business objects will cause these stored procedures to be regenerated as well. If the developer has indicated that the table supports history, then the stored procedures will contain appropriate functionality to modify the history table. In the preferred embodiment, all tables automatically have the timestamp checking capability. In addition, the DFW 122 keeps track of which user last changed a table, and that information is stored in a special column in the table, called UserName, and the DFW 122 and the BFW 112 ensure that the information in the column is accurate.

The External Framework

The External Framework (“EFW”) 132 resides within application enterprise software 130, as illustrated in FIG. 1. The application enterprise software 130 is an enterprise application integration package such as WEBMETHODS®, which is produced by webMethods, Inc. The EFW 132 is the platform that enables external clients to communicate with each other. In this respect, the BFW 112 is merely another external client. There are two forms that external client communications can take: synchronous and publish/subscribe. For the synchronous form, an external caller makes a call to the EFW 132. The EFW 132 then retrieves data from another external client. That data is then returned to the caller. The caller essentially waits for the data to be returned. For the publish/subscribe form, the external caller makes a call to the EFW 132 and returns immediately. The EFW 132 then forwards the call to each subscriber in his list of subscribers.

Each external client has its own logical grouping of functionality (sometimes called a “package”). The package is responsible for converting out-bound data from the external client to a suitable (preferably universal) format that is accepted in a heterogeneous application environment that can convey the information. Once in a suitable format, the data can then be sent to another external client. The package is also responsible for converting in-bound data in the UDM format into the external client's native format. An example of synchronous flow, as illustrated in FIG. 5, would be:

1. External client 502 calls the EFW 132. The call is in the client's 502 native format.

2. The call goes to the external client's package 504 in the EFW 132. The external client package 504 converts the call into UDM format within UDM Package 530.

3. The call, now in UDM format, then proceeds from the UDM Package 530 to another external client's package 512.

4. The external client package 512 converts the call from UDM format and into the external client's 510 native format.

5. The call then proceeds to the other external client 510.

The EFW 132 of the present invention is intended to be Robust, RAD, and Organized. The EFW 132 is robust for many reasons, including use of the Universal Data Model (“UDM”), use of UDM packages, use of XSD, and synchronous and publish/subscribe operation.

The EFW 132 contains an abstraction layer, the UDM. Whenever external data is fed into the EFW 132, the EFW 132 will translate the feed from the external vendor's format to a universal format (e.g., UDM). This layer keeps external clients independent of each other. They only depend on, for example, the UDM format.

The UDM package 530 provides UDM data the ability to persist itself. There exists a UDM database 530 that is different from the database 120. Remember that all data in the EFW 132 is converted into, for example, UDM format. After the data in the EFW 132 is converted, it can be persisted.

The format of all data in the EFW 132 is described by an XML Schema Definition (“XSD”). Each external client 502, 510, therefore, has its own XSD file. Again, the present invention itself is also an external client with respect to the EFW 132. Consequently, the BFW 112 has its own XSD as well. Moreover, the UDM package 530 has its own XSD. The use of XSD has many benefits. One benefit is the fact that data can be validated against the XSD. Data, therefore, coming into the EFW 132 or going out of the EFW 132 must be valid. The database wizard 121 provides help in generating two XSDs for an MSFastar package 520, namely MSFastar.xsd and UDM.xsd. The database wizard 121 will generate these from their database schema. Consequently, if the database schema changes, then the aforementioned files will change as well, and related data may no longer be valid. Run-time checking is employed to ensure that the data is synchronized with the databases 120 and 540.

The EFW 132 supports two forms of communication, namely, synchronous and publish/subscribe. The use of two forms of communication provides developers of EFW 132 packages many options for delivering information.

Each external client has its own package. Each of these packages is organized into folders. Folders include: InFromXXX; OutToXXX; publications; and subscriptions. With respect to InFromXXX folders, “XXX” is a place-holder name for the external client name. This folder contains all methods which are available to the corresponding client. The client invokes these methods so that it can call other external clients. From this folder, a developer can see all the methods that the external client can invoke in the EFW 132. With respect to OutToXXX folders, “XXX” is a place-holder name for the external client name. This folder has methods that are called by other external clients that want to communicate with this external client. From this folder, a developer can see all the methods which can be invoked on this external client. With respect to publications, this folder contains methods which this external client's packages use to publish data. Developers, by looking inside this package, can then see all the messages that they can subscribe to from this external client. The subscriptions folder has all the callback methods that this external client uses to receive subscriptions from others. From the subscriptions folder, a developer can easily see all of his/her subscriptions.

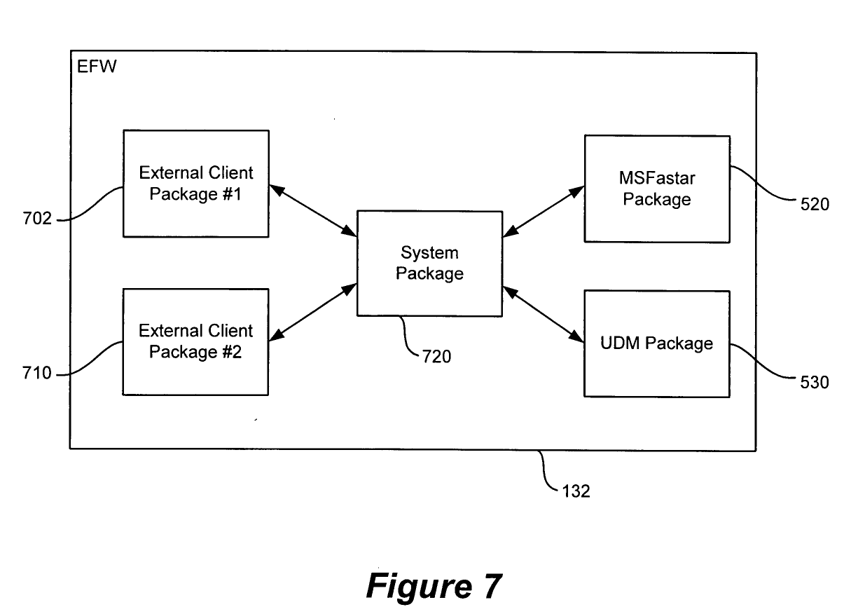

As illustrated in FIG. 7, in addition to each external client 502 and 510 having his own package 702 and 710, respectively, there are two other packages, namely the UDM package 530 and the system package 720, which are arranged in an operative fashion. The UDM package 530 is organized in the same manner as the external client packages 502 and 510 (see FIG. 5). The system package 720, however, merely contains utility methods that can be invoked by any package.

Both generated XSDs and reuse of code with the BFW 112 make the EFW 132 RAD. The XSD of the MSFastar package 520 and the UDM.XSD file of the MSFastar package 520 are generated from their database schema. When a developer generates code from a business object, the XSD file for the MSFastar package 520 is updated with that business object's schema. Because the database schema matches the business object schema, the XSD schema matches the database schema. Because the XSDs are generated, they do not have to be manually created and/or updated. Moreover, the same DbData objects and collections that are used by the BFW 112 are described in XSD file of the MSFastar package 520. The BFW 112 uses this XSD to reconstruct the DbData or collection.

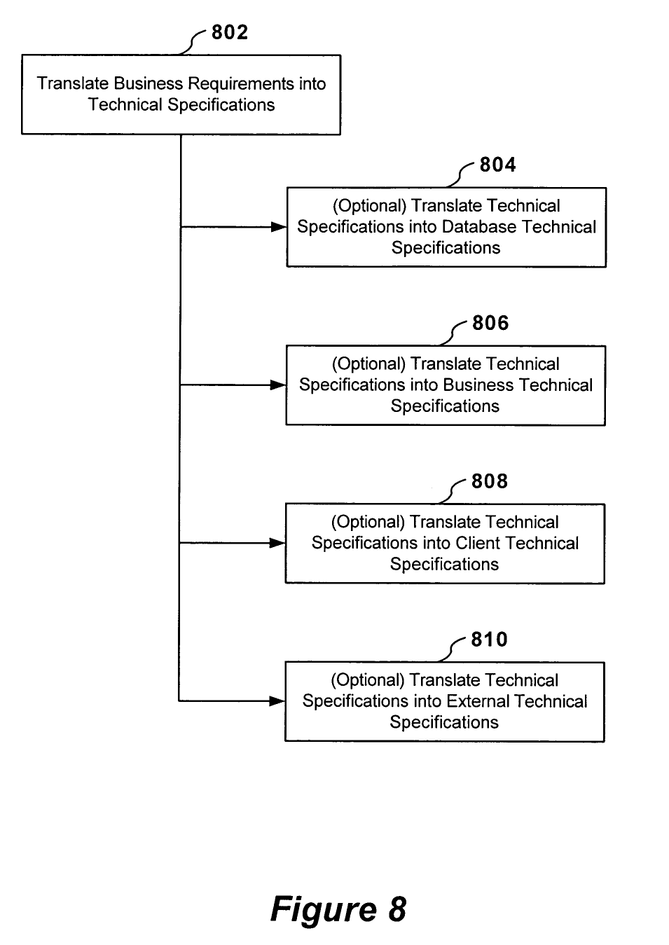

FIG. 8 illustrates the overall organization for generating one or more embodiments of the present invention. The framework of the present invention will generate a complete set of code necessary to implement an enterprise application. However, there are instances where customization of the generated methods and functions would be useful. To accommodate selective customization, the method of the present invention enables selective building (generation of methods and functions) of the enterprise application, as well as selective customization of those methods and functions.

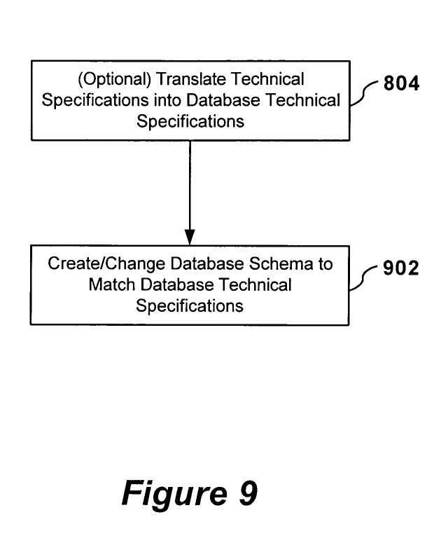

As illustrated in FIG. 8, the overall method of the present invention includes the translation of business requirements into technical specifications, step 802. Once step 802 is completed, there is a set of four optional sub-methods 804, 806, 808 and 810, which may be taken individually, selectively, or in any order or combination, by the developer to tailor the technical specifications that were generated in step 802 for specific purposes. Failure to implement one of the sub-methods 804, 806, 808, or 810 will not render the technical specifications generated in step 802 invalid. For example, the technical specifications from step 802 can be translated into database technical specifications in step 804. Similarly, the technical specifications from step 802 can be translated into business technical specifications in step 806. The technical specifications from step 802 can also be translated into client technical specifications in step 808. Finally, the technical specifications from step 802 can be translated into external technical specifications in step 810. Each of the four sub-methods 804, 806, 808, and 810 are illustrated in more detail in FIGS. 9, 10, 11, and 12, respectively.

FIG. 9 illustrates one of the optional sub-methods of the method of the present invention that is illustrated in FIG. 8. In this instance, the technical specifications from step 802 are translated into database technical specifications in step 804. Thereafter, in step 902, the schema of the database is either created or changed to match the database technical specifications that were generated in step 804.

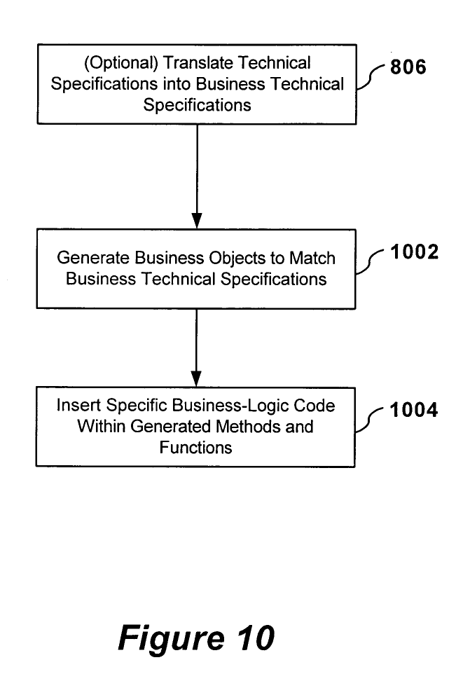

FIG. 10 illustrates another optional sub-method of the method of the present invention that is illustrated in FIG. 8. Here, the technical specifications (from step 802) are translated into business technical specifications in step 806. Once the business technical specifications have been generated, business objects can also be generated to match the business technical specifications in step 1002. The developer has the option to insert specific business-logic code within the generated methods and functions in step 1004 in order to tailor the resulting enterprise application to the problem at hand.

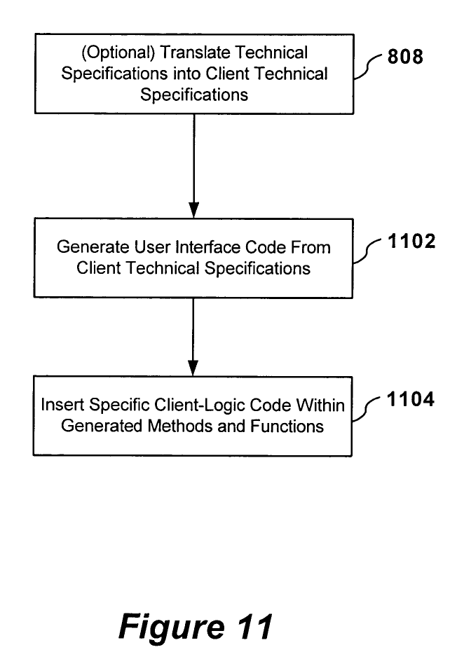

FIG. 11 illustrates yet another optional sub-method of the method of the present invention. In step 808, the technical specifications were translated into client technical specifications. In step 1102, the client technical specifications are used to generate user interface (“UI”) code. Specific (e.g., custom) client-logic code can then be inserted into the generated methods and functions of the user interface code, step 1104.

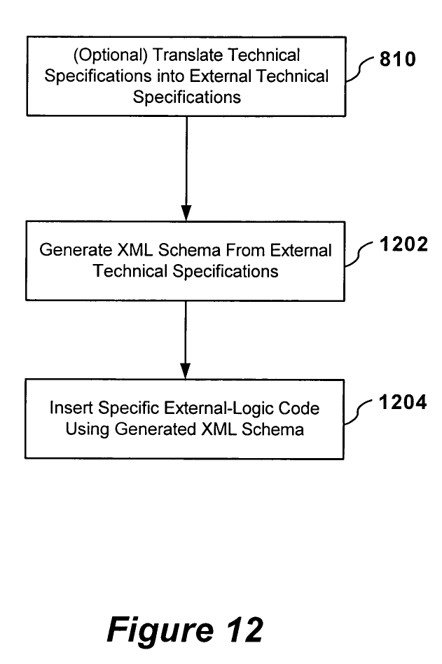

FIG. 12 illustrates still another optional sub-method of the method of the present invention. In step 810, the technical specifications (from step 802) were translated into external technical specifications. The external technical specifications are used to generate, for example, XML schema in step 1202. Other types of code or capabilities can be generated at this step, with XML schema merely being an illustrative example. In step 1204, the developer may insert specific external-logic code into the schema generated in step 1202 to tailor the behavior of the code to the problem at hand.

The invention, therefor, is well adapted to solve the problems identified and to attain the ends and advantages mentioned, as well as others inherent therein. While the invention has been depicted, described and is defined by reference to exemplary embodiments of the invention, such references do not imply a limitation on the invention, and no such limitation is to be inferred. The invention is capable of considerable modification, alteration and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is to be limited only by the spirit and scope of the appended claims, giving full cognizance to equivalents in all respects.

What is claimed is:

1. A system having a processor, memory operative with said processor, and storage media operative with said processor, said system further comprising:
a business framework;
a database framework operative with said business framework; and
a client framework operative with said business framework;
wherein said business framework, said database framework, and said client framework form an enterprise system framework.

2. The system of claim 1, wherein said enterprise system framework includes one or more rapid development services.

3. The system of claim 2, wherein said rapid development services include one or more developer services.

4. The system of claim 3, wherein said developer services allow one or more developers to execute said enterprise system framework from a local computer system without configuring said enterprise system framework.

5. The system of claim 3, wherein said developer services allow one or more developers to execute said enterprise system framework without security.

6. The system of claim 3, wherein said developer services allow one or more developers to debug one or more stored procedures.

7. The system of claim 1, wherein said business framework provides rapid development services to develop said business framework.

8. The system of claim 7, wherein said rapid development services generate a business framework abstraction of said business framework.

9. The system of claim 8, wherein said business framework abstraction allows said business framework to modify one or more business framework services that said business framework provides to one or more business objects.

10. The system of claim 8, wherein said business framework abstraction allows said business framework to modify a business framework methodology.

11. The system of claim 7, wherein a set of central services on one or more business objects includes administrative services.

12. The system of claim 11, wherein said administrative services allow said business framework to track system usage.

13. The system of claim 1, wherein said business framework provides a set of central services for one or more business objects.

14. The system of claim 13, wherein said set of central services on business objects includes transaction services.

15. The system of claim 14, wherein said transaction services are provided by a COM+ transaction server.

16. The system of claim 14, wherein said transaction services are provided by said business framework.

17. The system of claim 13, wherein said central services on said one or more business objects include security services to control user access to said one or more business objects.

18. The system of claim 13, wherein said central services on said one or more business objects include security services to control user access to one or more external objects.

19. The system of claim 13, wherein said central services on said one or more business objects include security services to control user access to one or more database objects.

20. The system of claim 13, wherein said central services on said one or more business objects include security services to control user access to one or more client objects.

21. The system of claim 17, wherein said security services utilize one or more services provided by an external service provider.

22. The system of claim 17, wherein said security services are abstracted from an external service provider's implementation.

23. The system of claim 17, wherein said security services include automatic generation of special components that form walls around said one or more business objects to control access to said one or more business objects.

24. The system of claim 13, wherein said set of central services on said one or more business objects includes organizational services.

25. The system of claim 24, wherein said organizational services include a compulsory belonging of business objects to groups.

26. The system of claim 25, wherein said groups include one or more business groups.

27. The system of claim 25, wherein one or more special groups includes groups identifying business objects as belonging to said client framework.

28. The system of claim 24, wherein said organizational services include compulsory naming conventions for said one or more business objects.

29. The system of claim 13, wherein said set of central services on business objects includes protocol services.

30. The system of claim 29, wherein said protocol services enable a protocol to be abstracted from communication between said one or more business objects and said client framework.

31. The system of claim 29, wherein said protocol services enable a protocol to be abstracted from communication between said one or more business objects and an external framework.

32. The system of claim 29, wherein said protocol services enable a protocol to be abstracted from communication between said one or more business objects and a database framework.

33. The system of claim 29, wherein said protocol services enable a protocol to be abstracted from communication between said one or more business objects and one or more client objects.

34. The system of claim 29, wherein said protocol services enable different business objects to use different protocols.

35. The system of claim 34, wherein said one or more business objects uses a protocol based on a special group to which they belong.

36. The system of claim 13, wherein said one or more business objects are distributed on more than one server.

37. The system of claim 13, wherein said one or more business objects are distributed on more then one client.

38. The system of claim 13, wherein said one or more business objects are distributed on more then one database.

39. The system of claim 13, wherein said one or more business objects are distributed on more then one external object.

40. The system of claim 13, wherein said set of central services includes adapter services.

41. The system of claim 40, wherein said adapter services allow said one or more business objects to invoke other computer systems.

42. The system of claim 41, wherein said computer systems include computer systems implementing said database framework.

43. The system of claim 42, wherein an adapter that communicates with said database framework allows said one or more business objects to be fetched from a database and placed in one of said business objects in one operation.

44. The system of claim 42, wherein an adapter that communicates with said database framework allows said one or more business objects to be fetched from a data repository and placed in one of said business objects in one operation.

45. The system of claim 41, wherein said computer systems include computer systems implementing an external framework.

46. The system of claim 40, wherein said adapter services allow business objects to be abstracted from an adapter used by one or more of said business objects.

47. The system of claim 46, wherein said adapter that said business object uses is determined by one or more special groups to which said business object belongs.

48. The system of claim 40, wherein said adapter services allow one or more adapters to communicate with computer systems in a protocol supported by said computer systems.

49. The system of claim 13, wherein said set of central services on said business objects includes error-handling services.

50. The system of claim 49, wherein said error-handling services support a capture of one or more operating system exceptions.

51. The system of claim 49, wherein said error-handling services support a capture of one or more COM errors.

52. The system of claim 49, wherein said error-handling services include logging errors in an event viewer when errors are captured.

53. The system of claim 49, wherein said error-handling services include logging errors in an event viewer when errors are detected.

54. The system of claim 49, wherein said error-handling services include generating at least one call stack.

55. The system of claim 13, wherein said set of central services includes layering services.

56. The system of claim 55, wherein said layering services include a client framework layer.

57. The system of claim 55, wherein said layering services include an external framework layer.

58. The system of claim 55, wherein said layering services include a reporting system layer.

59. The system of claim 55, wherein said layering services include a client framework layer, an external framework layer, and a reporting system layer.

60. The system of claim 59, wherein said client framework layer enables said client framework and said business framework in an optimized manner.

61. The system of claim 60, wherein said optimized manner includes having said client framework and said business framework interact with a minimum of round-trips.

62. The system of claim 60, wherein said optimized manner includes having said client framework and said business framework interact in an abstracted fashion.

63. The system of claim 59, wherein said reporting system layer enables a reporting system and said business framework to operate in an abstracted fashion.

64. The system of claim 13, wherein said set of central services on business objects includes life-cycle services.

65. The system of claim 64, wherein said life-cycle services include notifying said one or more business objects after said business objects are created.

66. The system of claim 64, wherein said life-cycle services include notifying said one or more business objects after said business objects are updated.

67. The system of claim 64, wherein said life-cycle services include notifying said one or more business objects after said business objects are deleted.

68. The system of claim 64, wherein said life-cycle services include notifying said one or more business objects after said business objects are fetched.

69. The system of claim 64, wherein said life-cycle services include notifying said one or more business objects before said business objects are updated.

70. The system of claim 64, wherein said life-cycle services include notifying said one or more business objects before said business objects are deleted.

71. The system of claim 64, wherein said life-cycle services include notifying said one or more business objects before said business objects are fetched.

72. The system of claim 13, wherein said set of central services includes rapid development services.

73. The system of claim 72, wherein said rapid development services allow said one or more business objects that are not tied to a database to be generated automatically.

74. The system of claim 73, wherein said one or more business objects consist of a layer of non-generated code and a layer of generated-if-not-existing code.

75. The system of claim 72, wherein said services allow said one or more business objects that are tied to a database table to be generated automatically.

76. The system of claim 75, wherein said one or more business objects consist of a layer of non-generated code, a layer of generated code, and a layer of generated-if-not-existing code.

77. The system of claim 76, wherein said layer of non-generated code provides generic services for said business object.

78. The system of claim 77, wherein said generic services allow business objects to make copies of themselves automatically.

79. The system of claim 76, wherein said layer of non-generated code guarantees that said layer of generated code implements one or more certain services.

80. The system of claim 76, wherein said layer of non-generated code contains services to assist said layer of generated code.

81. The system of claim 76, wherein said layer of generated code and said layer of generated-if-not-existing code are created by a third-party tool.

82. The system of claim 76, wherein said layer of generated code is overwritten by a developer.

83. The system of claim 76, wherein said layer of generated-if-not-existing code is overwritten by a developer.

84. The system of claim 75, wherein said business objects include state objects, collections of state objects, and stateless business objects.

85. The system of claim 84, wherein said state objects can encapsulate one row of a database table such that encapsulation is done within said layer of generated code for said state object.

86. The system of claim 85, wherein said layer of generated code can automatically contain one or more get member functions where said member functions match a database schema.

87. The system of claim 85, wherein said layer of generated code can automatically contain one or more put member functions where said member functions match a database schema.

88. The system of claim 86, wherein if said layer of generated code contains said get and put member functions, then there exists compile-time checking between said business object and a database schema.

89. The system of claim 85, wherein said layer of generated code can automatically contain one or more member variables where said one more member variables matches a database schema.

90. The system of claim 89, wherein said member variables are objects when a corresponding database type is a calendar.

91. The system of claim 85, wherein said layer of generated code can contain status flags.

92. The system of claim 84, wherein said collection of state objects encapsulate zero or more state objects.

93. The system of claim 92, wherein said state collection object is compile-time bound to a corresponding state object.

94. The system of claim 92, wherein said collection of state objects is implemented using a container algorithm.

95. The system of claim 94, wherein said container algorithm is abstracted into a separate object.

96. The system of claim 84, wherein said stateless business object can include methods for communicating with stored procedures associated with a database table associated with a business object.

97. The system of claim 84, wherein said stateless business objects are compile-time bound to corresponding state objects and to collection of state objects.

98. The system of claim 72, wherein said services allow run-time binding of business objects.

99. The system of claim 72, wherein said rapid development services allow business objects to inherit from each other.

100. The system of claim 72, wherein said rapid development services allow business objects to convert automatically from one business object to another.

101. The system of claim 72, wherein said rapid development services enable automatic replay of deadlock database errors when detected.

102. The system of claim 72, wherein said services enable business objects to keep copies, optionally and automatically, of their old state.

103. The system of claim 13, wherein said set of central services on business objects includes messaging services.

104. The system of claim 103, wherein said messaging services allow business objects to send messages to other users.

105. The system of claim 103, wherein said messaging services include message queue services.

106. The system of claim 105, wherein said message queue services enable asynchronous method invocation between business objects.

107. The system of claim 105, wherein said message queue services enable one or more business objects to be invoked immediately.

108. The system of claim 105, wherein said message queue services enable one or more business objects to be invoked in the event of a failure.

109. The system of claim 105, wherein said message queue services are available even when an application is not configured in a transaction server.

110. The system of claim 13, wherein said set of central services for said business objects include asynchronous services.

111. The system of claim 110, wherein said asynchronous services include an ability for business objects to invoke each other in an asynchronous manner.

112. The system of claim 110, wherein said asynchronous services do not preclude the ability for one or more business objects to invoke each other in a synchronous manner.

113. The system of claim 110, wherein said asynchronous services are available if an application is not configured in a transaction server.

114. The system of claim 110, wherein said asynchronous services are optimized for high-performance communication.

115. The system of claim 13, wherein said set of central services for said business objects includes scheduling services.

116. The system of claim 115, wherein said scheduling services allow business objects to be invoked once at a given date and time.

117. The system of claim 13, wherein set of central services on business objects includes reporting services.

118. The system of claim 117, wherein said reporting services allow integration with an external report application.

119. The system of claim 117, wherein said reporting services provide rapid development for reports.

120. The system of claim 119, wherein said reporting services include an external report application having binding functions in state objects.

121. The system of claim 1, wherein said database framework consists of one or more stored procedures, one or more user-defined types, one or more tables, and one or more views in a relational database.

122. The system of claim 121, wherein all access to said database framework is through said stored procedures.

123. The system of claim 121, wherein said stored procedures, said user-defined types, tables, and views all follow one or more naming conventions.

124. The system of claim 123, wherein said naming conventions allow a third-party tool to identify all insert stored procedures, all update stored procedures, all delete stored procedures, and all query stored procedures that correspond to each table and to each view in said database.

125. The system of claim 124, wherein said identification allows a third-party tool to generate automatically all insert stored procedures, update stored procedures, and all delete stored procedures that correspond to all tables and views.

126. The system of claim 125, wherein said generation allows said stored procedures to support simultaneous access by multiple users.

127. The system of claim 125, wherein said generation allows stored procedures to support keeping history automatically.

128. The system of claim 125, wherein said generation allows said stored procedures to support more services rapidly.

129. The system of claim 121, wherein said user-defined types enables one or more database columns to identify themselves as components within a unit system.

130. The system of claim 1, wherein said client framework provides rapid development services for said client framework.

131. The system of claim 130, wherein said rapid development services enable said client framework to change one or more central services for one or more client forms and one or more client dialogs en masse.

132. The system of claim 1, wherein said client framework provides a set of central services for client forms, client dialogs, and HTML pages.

133. The system of claim 132, wherein said set of central services includes abstraction services to abstract client forms and client dialogs from a web browser that hosts said client forms and said client dialogs.

134. The system of claim 132, wherein said set of central services includes providing life-cycle services.

135. The system of claim 134, wherein said life-cycle services include notifying said client forms and said client dialogs to initialize said client forms and said client dialogs and further notifying said client forms and said client dialogs when a command is invoked.

136. The system of claim 134, wherein said life-cycle services include notifying one or more of said client forms to initialize said one or more client forms and further notifying said one or more client forms when a command is invoked.

137. The system of claim 136 wherein said command is a get command.

138. The system of claim 136 wherein said command is a save command.

139. The system of claim 136 wherein said command is a refresh command.

140. The system of claim 136 wherein said command is a delete command.

141. The system of claim 134, wherein said life-cycle services include notifying one or more of said client dialogs to initialize said one or more client dialogs and further notifying said one or more client dialogs when a command is invoked.

142. The system of claim 141, wherein said command is a get command.

143. The system of claim 141, wherein said command is a save command.

144. The system of claim 141, wherein said command is a refresh command.

145. The system of claim 141, wherein said command is a delete command.

146. The system of claim 134, wherein said life-cycle services allows said client forms and said client dialogs to override default behavior by not passing said life-cycle messages to said client framework.

147. The system of claim 132, wherein said set of central services include performance services.

148. The system of claim 147, wherein said performance services include caching services.

149. The system of claim 148, wherein said caching services include routing all outbound calls through a cache so that an outbound call need not be made if one or more results are already in said cache.

150. The system of claim 148, wherein said cache is written in C++.

151. The system of claim 147, wherein said performance services include asynchronous services.

152. The system of claim 151, wherein said asynchronous services include services which enable one or more client objects to invoke one or more server objects in an asynchronous manner.

153. The system of claim 151, wherein said asynchronous services include asynchronous downloading services.

154. The system of claim 153, wherein said asynchronous downloading services enable the downloading of said client forms and other objects as a background process.

155. The system of claim 147, wherein said performance services include making said client forms, said client dialogs and said client framework light-weight.

156. The system of claim 147, wherein said performance services include using said business objects natively.

157. The system of claim 132, wherein said central services include persistence services.

158. The system of claim 157, wherein said persistence services allow HTML page state to be preserved.

159. The system of claim 132, wherein said set of central services includes rapid development services.

160. The system of claim 159, wherein said rapid development services include automatic updating of a status flag of said one or more business objects.

161. The system of claim 159, wherein said rapid development services include property services.

162. The system of claim 161, wherein said property services enable one or more controls on HTML pages to exhibit behavior based on properties defined for said control.

163. The system of claim 162, wherein said exhibited behavior allows said client forms and said client dialogs to invoke business objects without coding.

164. The system of claim 162, wherein said exhibited behavior includes loading one or more controls from specific business object data, taking action on a control selection, taking action when a get, a save, a delete, a refresh, and a history command is invoked.

165. The system of claim 159, wherein said rapid development services, said client forms and said client dialogs are written in Visual Basic.

166. The system of claim 159, wherein said rapid development services include integration with a deployment apparatus.

167. The system of claim 166, wherein said integration allows a deployment apparatus to discover all binaries needing to be installed on a client machine.

168. The system of claim 1, wherein an external framework operates within an enterprise application interface.

169. The system of claim 1, wherein an external framework provides a set of central services.

170. The system of claim 169, wherein said set of central services includes protocol services.

171. The system of claim 170, wherein said protocol services include a protocol framework for incorporating new protocols into said system.

172. The system of claim 169, wherein said set of central services includes communication services.

173. The system of claim 172, wherein said communication services include synchronous invocation services.

174. The system of claim 173, wherein said synchronous invocation services allow synchronous method invocation between objects within said external framework and one or more external clients.

175. The system of claim 172, wherein said communication services include publish invocation services.

176. The system of claim 172, wherein said communication services include subscribe invocation services.

177. The system of claim 175, wherein said publish invocation services allow external framework objects to publish events asynchronously.

178. The system of claim 175, wherein said subscribe invocation services allow external framework objects to publish events asynchronously.

179. The system of claim 169, wherein said central services include abstraction services.

180. The system of claim 179, wherein said abstraction services allow one or more external clients to be abstracted from said external framework.

181. The system of claim 179, wherein said abstraction services allow said business framework to be abstracted from said external framework.

182. The system of claim 169, wherein said set of central services includes rapid development services.

183. The system of claim 182, wherein said rapid development services include automatic run-time validation between one or more external clients and said external framework.

184. The system of claim 182, wherein said rapid development services include automatic run-time validation between said external framework and said business framework.

185. The system of claim 3, wherein said developer services allow developers to debug said enterprise system framework with security.

186. The system of claim 3, wherein said developer service allows a developer to debug said enterprise system framework from a local computer system without having to configure said enterprise system framework in COM+, a web server, or any other third-party server software.

187. The system of claim 3, wherein said developer service allows a developer to debug said enterprise system framework without security.

188. The system of claim 7, wherein said rapid development services generate a business framework abstraction of said business framework from one or more business objects.

189. The system of claim 7, wherein said rapid development services generate a business framework abstraction of said business framework from one or more business objects through a layer of generated code.

190. The system of claim 8, wherein said business framework abstraction allows said business framework to modify a business framework methodology without affecting one or more business objects.

191. The system of claim 11, wherein said administrative services allow said business framework to track one or more users of said system.

192. The system of claim 11, wherein said administrative services allow said business framework to garner performance metrics.

193. The system of claim 25, wherein said groups include one or more special groups.

194. The system of claim 193, wherein said special groups include groups identifying business objects as belonging to an external framework.

195. The system of claim 193, wherein said special groups include groups identifying business objects as belonging to a reporting system.

196. The system of claim 13, wherein said one or more business objects is distributed on more than one server with performance being optimized for such distribution.

197. The system of claim 40, wherein said adapter services allow one or more adapters to communicate with computer systems in a data access technology supported by said computer systems.

198. The system of claim 49, wherein said error-handling services include generating at least one call stack that includes line numbers.

199. The system of claim 49, wherein said error-handling services include generating at least one call stack that includes line numbers when errors are captured.

200. The system of claim 55, wherein said layering services include a client framework layer.

201. The system of claim 55, wherein said layering services include an external framework layer.

202. The system of claim 55, wherein said layering services include a reporting system layer.

203. The system of claim 59, wherein said client framework layer enables said client framework and said business framework to interact in an abstracted fashion.

204. The system of claim 59, wherein said external framework layer enables an external framework and said business framework to interact in an abstracted fashion.

205. The system of claim 64, wherein said life-cycle services include notifying said one or more business objects before and after said business objects are created.

206. The system of claim 64, wherein said life-cycle services include notifying said one or more business objects before and after said business objects are updated.

207. The system of claim 64, wherein said life-cycle services include notifying said one or more business objects before and after said business objects are deleted.

208. The system of claim 64, wherein said life-cycle services include notifying said one or more business objects before and after said business objects are fetched.

209. The system of claim 72, wherein said rapid development services allow said one or more business objects to be generated automatically.

210. The system of claim 72, wherein said services allow said one or more business objects that are tied to a database view to be generated automatically.

211. The system of claim 76, wherein said layer of generated code is overwritten constantly.

212. The system of claim 75, wherein said business objects include state objects.

213. The system of claim 75, wherein said business objects include collections of state objects.

214. The system of claim 75, wherein said business objects include stateless business objects.

215. The system of claim 84, wherein said state objects can encapsulate one row of a database view such that encapsulation is done within said layer of generated code for said state object.

216. The system of claim 85, wherein said layer of generated code can automatically contain get and put member functions where they match a database schema.

217. The system of claim 86, wherein if said layer of generated code contains said get and put member functions, then there exists compile-time checking between said business object and said database schema.

218. The system of claim 85, wherein said layer of generated code can automatically contain one or more member variables where said one or more member variables match a database schema.

219. The system of claim 89, wherein said member variables are objects where a corresponding database type is a member of the group consisting of calendar, unit, primary key, and binary file.

220. The system of claim 85, wherein said layer of generated code can contain status flags.

221. The system of claim 89, wherein said member variables are objects when a corresponding database type is a unit.

222. The system of claim 89, wherein said member variables are objects when a corresponding database type is a primary key.

223. The system of claim 89, wherein said member variables are objects when a corresponding database type is a binary file.

224. The system of claim 92, wherein said collection of state objects is implemented using a linked-list.

225. The system of claim 92, wherein said collection of state objects is implemented using a hash-table.

226. The system of claim 84, wherein said stateless business object can include methods for communicating with stored procedures associated with a database view associated with a business object.

227. The system of claim 72, wherein said services allow run-time binding of business objects with XSD schema.

228. The system of claim 227, wherein if said XSD schema changes, then a validation of said business object fails.

229. The system of claim 72, wherein said rapid development services allow business objects to inherit from a set of two or more related objects to form a set of derived related objects such that when one of said derived related objects is changed, then each of object in said set of derived related objects is changed.

230. The system of claim 72, wherein said rapid development services allow business objects to inherit from a set of two or more related objects to form a set of derived related objects such that when one of said derived related objects is deleted, then each object of said set of derived related objects is deleted.

231. The system of claim 100, wherein said rapid development services that allow business objects to convert automatically from one business object to another are overridden.

232. The system of claim 103, wherein said messaging services allow business objects to send email other users.

233. The system of claim 103, wherein said messaging services allow business objects to send messages to other computer systems.

234. The system of claim 103, wherein said messaging services allow business objects to send email to other computer systems.

235. The system of claim 105, wherein said message queue services enable one or more business objects to be invoked at a specific date and time.

236. The system of claim 115, wherein said scheduling services allow business objects to be invoked periodically at specified intervals.

237. The system of claim 123, wherein said naming conventions allow a third-party tool to identify all insert stored procedures that correspond to each table and to each view in said database.

238. The system of claim 123, wherein said naming conventions allow a third-party tool to identify all updated stored procedures that correspond to each table and to each view in said database.

239. The system of claim 123, wherein said naming conventions allow a third-party tool to identify all deleted stored procedures that correspond to each table and to each view in said database.

240. The system of claim 123, wherein said naming conventions allow a third-party tool to identify all query stored procedures that correspond to each table and to each view in said database.

241. The system of claim 124, wherein said identification allows a third-party tool to generate automatically all insert stored procedures that correspond to all tables and views of said database.

242. The system of claim 124, wherein said identification allows a third-party tool to generate automatically updated stored procedures that correspond to all tables and views of said database.

243. The system of claim 124, wherein said identification allows a third-party tool to generate automatically all deleted stored procedures that correspond to all tables and views of said database.

244. The system of claim 1, wherein said client framework provides a set of central services for one or more client forms.

245. The system of claim 1, wherein said client framework provides a set of central services for one or more client dialogs.

246. The system of claim 1, wherein said client framework provides a set of central services for one or more HTML pages.

247. The system of claim 134, wherein said life-cycle services include notifying said client forms and said client dialogs to initialize said client forms and said client dialogs and to notifying said client forms and said client dialogs when a user invokes a command.

248. The system of claim 247, wherein said command is a get command.

249. The system of claim 247, wherein said command is a save command.

250. The system of claim 247, wherein said command is a refresh command.

251. The system of claim 247, wherein said command is a delete command.

252. The system of claim 134, wherein said life-cycle services include notifying one or more of said client forms to initialize one or more of said client forms and to notifying one or more of said client forms when a user invokes a command.

253. The system of claim 252, wherein said command is a get command.

254. The system of claim 252, wherein said command is a save command.

255. The system of claim 252, wherein said command is a refresh command.

256. The system of claim 252, wherein said command is a delete command.

257. The system of claim 134, wherein said life-cycle services include notifying one or more of said client dialogs to initialize one or more of said client dialogs and to notifying one or more of said client dialogs when a user invokes a command.

258. The system of claim 257, wherein said command is a get command.

259. The system of claim 257, wherein said command is a save command.

260. The system of claim 257, wherein said command is a refresh command.

261. The system of claim 257, wherein said command is a delete command.

262. The system of claim 162, wherein said exhibited behavior includes loading one or more controls from specific business object data, taking action on a control selection, taking action when a command is invoked.

263. The system of claim 262, wherein said command is a get command.

264. The system of claim 262, wherein said command is a get command.

265. The system of claim 262, wherein said command is a save command.

266. The system of claim 262, wherein said command is a delete command.

267. The system of claim 262, wherein said command is a refresh command.

268. The system of claim 262, wherein said command is a history command.

269. The system of claim 177, wherein said publish invocation services allow one or more clients within said external framework to subscribe to said events.

270. The system of claim 177, wherein said subscribe invocation services allow one or more clients within said external framework to subscribe to said events.

271. The system of claim 177, wherein said publish invocation services allow one or more client outside of said external framework to subscribe to said events.

272. The system of claim 177, wherein said subscribe invocation services allow one or more client outside of said external framework to subscribe to said events.

273. The system of claim 179, wherein all information in said external framework is in a universal format.

274. A framework for generating objects comprising:
a business framework, said business framework constructed and arranged to support one or more services to one or more business objects;
a client framework operatively connected to said business framework, said client framework constructed and arranged to support one or more services for one or more client forms;
a database framework operatively connected to said business framework, said database framework constructed and arranged to translate functions between said business objects of said business framework and a database; and
an external framework operatively connected to said business framework, said external framework constructed and arranged to form one or more templates, said external framework further constructed and arranged to enable the integration with other external vendor software;
wherein said business objects of said business framework are created by said client, are stored within said database, and operate with said external vendor software.

275. The framework as in claim 274, wherein said business framework implements a security model.

276. The framework as in claim 274, wherein said business framework implements a plurality of security models.

277. A method for generating code comprising:
providing one or more data structures to a database framework;
providing user interface information to a client framework;
providing code instructions to a business framework; and
translating business requirements into technical specifications.

278. The method of claim 277 further comprising:
translating said technical specifications into database technical specifications.

279. The method of claim 278 further comprising:
creating database schema to match said database technical specifications.

280. The method of claim 278 further comprising:
changing database schema to match said database technical specifications.

281. The method of claim 277 further comprising:
translating said technical specifications into business technical specifications.

282. The method of claim 281 further comprising:
generating one or more business objects to match said business technical specifications.

283. The method of claim 282 further comprising:
inserting business-logic within said business objects.

284. The method of claim 277 further comprising:
translating said technical specifications into client technical specifications.

285. The method of claim 284 further comprising:
generating user interface code from said client technical specifications.

286. The method of claim 285 further comprising:
inserting client-logic within said interface code.

287. The method of claim 277 further comprising:
translating technical specifications into external technical specifications.

288. The method of claim 287 further comprising:
generating a schema from said external technical specifications.

289. The method of claim 288 further comprising:
inserting external logic into said schema.

290. The method of claim 288, wherein said schema is XML schema.

291. The system of claim 24, wherein said organizational services allow business objects to belong to groups.

292. The system of claim 291, wherein said groups include one or more business groups.

293. The system of claim 291, wherein one or more special groups include groups identifying business objects as belonging to said client framework.

294. The system of claim 1, said system further comprising:
an external framework operative with said business framework.

295. A system having a processor, memory operative with said processor, and storage media operative with said processor, said system further comprising:
a business framework;
a database framework operative with said business framework;
a client framework operative with said business framework; and
an external framework operative with said business framework;
wherein said business framework, said database framework, said client framework, and said external framework form an enterprise system framework.
